(19) United States
(12) Patent Application Publication
(10) Pub. No.: US 2026/0094438 A1
(43) Pub. Date: Apr. 2, 2026

(54) METHOD AND SYSTEM FOR REAL-TIME EVENT SUMMARIZATION

(71) Applicant: ACCENTURE GLOBAL SOLUTONS LIMITED, Dublin 4 (IE)

(72) Inventors: Kamal MANNAR, Singapore (SG); Nita WANG, San Diego, CA (US); Hayley Skye DARUKHANAVALA, North Aurora, IL (US); Lan GUAN, New York, NY (US); Elizabeth Ann KEATING, New Milford, CT (US)

(73) Assignee: ACCENTURE GLOBAL SOLUTONS LIMITED, Dublin 4 (IE)

(21) Appl. No.: 18/903,669

(22) Filed: Oct. 1, 2024

(51) Int. Cl. G06V 20/40

(52) U.S. Cl. CPC G06V 20/44; G06V 20/41

(57) ABSTRACT

Systems and methods for summarizing a real-time event are disclosed herein. A system obtains a set of multimedia data feeds from image capturing devices, wherein the set of multimedia data feeds correspond to a real-time event. The system processes the obtained set of multimedia data feeds using model hyperparameters and sequences the processed set of multimedia data feeds in a predetermined order. The system also obtains one or more input prompts corresponding to the set of multimedia data feeds. The system generates an output representation of the real-time event by encoding the sequenced set of multimedia data feeds and the obtained one or more input prompts using a trained vision encoder model, wherein the generated output representation corresponds to a multi-resolution summary image of the real-time event at a time instance. The system also predicts one or more actions performed in the generated output representation using an action prediction model.

### TECHNICAL FIELD

Various embodiments described herein relate generally to system, method, and non-transitory computer readable medium for summarizing a real-time event using a custom multi-modal model.

### BACKGROUND

Recent advances in the fields of digital imaging and electronics have changed the dynamics of streaming multimedia data feeds to include real-time multimedia data feeds obtained from different image capturing devices. Such multimedia data feeds correspond to a real-time event and are used for multiple purposes. For example, Closed-Circuit Television (CCTV) video feeds are used for security and operations, live multicamera video feeds are used for sports, and/or the like.

The multimedia data feeds obtained from the different image capturing devices create a large volume of unstructured data. Due to which, an amount of assistance that users required to efficiently consume the multimedia data feeds and to derive actions of interest from the multimedia data feeds increases. Such requirements are fulfilled by generating a summary of the real-time event corresponding to the multimedia data feeds. The summary is further used to derive the actions of interest, identify anomalies or non-optimal operational events, and/or the like. Therefore, automated summarization of the multimedia data feeds in real-time has significant value across different industries.

Existing systems train custom models (e.g., neural network models, Large Language Models (LLMs), and/or the like) for detection of objects and actions of interest in the multimedia data feeds. Based on detection of the objects and the actions of interest, the existing systems generate the summary of the real-time event. However, the existing systems require a large volume of training datasets for training the custom models. Also, the existing systems require additional/supplementary training datasets for training the custom models, if there exists a need for detecting a sequence of actions. Therefore, a significant effort is required to create the training datasets and train the custom models for detection of the objects and the actions of interest. Also, a complexity increases when the actions of interest are across time (video stream) and across the different image capturing devices.

Further, the trained custom models may not be adapted across the different industries, as the training datasets used for training of the custom models include openly available data. Therefore, accuracy and usage of the custom models for different real-time events may be limited.

In addition, the multimedia data feeds obtained for the real-time event include a combination of different data types (including text, images, videos, and/or the like) captured for the same real-time event using the different image capturing devices at different time intervals and with multiple resolution. However, processing of such multimedia data feeds using the custom models for generating the summary pose several challenges, which include reducing effectiveness and accuracy of the summary, and increasing latency and hallucination of the custom models.

### SUMMARY

In an aspect, the present disclosure relates to a system including a processor, and a memory coupled to the processor, wherein the memory includes processor-executable instructions, which on execution, cause the processor to obtain a set of multimedia data feeds from a plurality of image capturing devices, wherein the set of multimedia data feeds correspond to a real-time event and wherein the set of multimedia data feeds correspond to a time-series data captured at a plurality of time intervals and a multi-resolution data captured from the plurality of image capturing devices, process the obtained set of multimedia data feeds using a plurality of model hyperparameters, wherein the plurality of hyperparameters includes a frame rate, a domain specific semantic compression, a multimedia segment length, and overlap between multimedia segments, sequence the processed set of multimedia data feeds in a predetermined order based on the time-series data and the multi-resolution data, obtain at least one input prompt corresponding to the set of multimedia data feeds from at least one input source, generate an output representation of the real-time event by encoding the sequenced set of multimedia data feeds and the obtained at least one input prompt using a trained vision encoder model, wherein the generated output representation corresponds to a multi-resolution summary image of the real-time event at a time instance, predict at least one action performed in the generated output representation using an action prediction model, wherein the at least one action includes at least one of an activity, a function, and a movement corresponding to the real-time event, and output the predicted at least one action on a user interface of a user device.

In some examples, the processor may be further configured to validate a model performance of the action prediction model based on key performance factors, wherein the key performance factors include a data sensitivity factor, a data specificity factor, and a ground truth level of the action prediction model and tune the action prediction model to generate an updated action based on results of validation.

In some examples, to process the obtained set of multimedia data feeds using the plurality of model hyperparameters, the processor may be configured to identify a type of multimedia data obtained by analyzing a file format, a data size, and contents of multimedia data, identify at least one of a type of objects, a position of objects, gestures performed within the obtained set of multimedia data feeds, a text data, and an audio data using a computer vision model, select at least one appropriate processing model for processing the obtained set of multimedia data feeds based on the identified type of multimedia data, and the identified type of objects, the position of objects, the gestures performed within the obtained set of multimedia data feeds, the text data, and the audio data, process the obtained set of multimedia data feeds using the selected at least one appropriate processing model.

In some examples, the processor may be configured to tune the plurality of model hyperparameters based on the selected at least one appropriate processing model, wherein the selected at least one appropriate processing model includes a computer vision model and an audio model, wherein the computer vision model includes at least one of an object detection, an object tracking, a person detection, a person tracking, a semantic segmentation, a semantic compression, a multi-camera person recognition, and a multi-camera object recognition, wherein the audio model includes a noise reduction, a speech detection, and a speech diarization, and retrain a vision encoder model based on the tuned plurality of model hyperparameters.

In some examples, to obtain the at least one input prompt corresponding to the set of multimedia data feeds from the at least one input source, the processor may be configured to obtain text prompts from the at least one input source at real-time based on a type of the set of multimedia data feeds, wherein the at least one input source includes one of a user input and a model input.

In some examples, to process the obtained set of multimedia data feeds using the plurality of model hyperparameters, the processor may be configured to identify an event of interest within the set of multimedia data feeds captured from the plurality of image capturing devices, determine a plurality of patterns corresponding to the identified event of interest with respect to a plurality of time instances by correlating each media frame with a subsequent media frame of the set of multimedia data feeds, and process the obtained set of multimedia feeds based on the determined plurality of patterns corresponding to the identified event of interest.

In some examples, to generate the output representation of the real-time event by encoding the sequenced set of multimedia data feeds and the obtained at least one input prompt using the trained vision encoder model, the processor may be configured to encode the sequenced set of multimedia data feeds using a computer vision encoder layer of the trained vision encoder model, encode the obtained at least one input prompt using a word embedding layer of the trained vision encoder model, correlate the encoded set of multimedia data feeds with the obtained at least one input prompt to identify an action of interest, and generate the output representation of the real-time event based on the correlation, wherein the output representation indicates the action of interest.

In some examples, to predict the at least one action performed in the generated output representation using the action prediction model, the processor may be configured to identify at least one of a type of objects, a position of objects, gestures performed within the obtained set of multimedia data feeds using a computer vision model, classify the set of multimedia data feeds into domain specific events based on the at least one of the type of the objects, the position of the objects, and the gestures performed, generate a confidence score for each of the classified set of multimedia data feeds using the action prediction model, and predict the at least one action performed in the generated output representation using the generated confidence score.

In some examples, the processor may be configured to determine at least one pattern with an object within the obtained set of multimedia data feeds using the trained vision encoder model and detect a state of the object based on the determined at least one pattern, wherein the state of the object includes one of a mental state and a physical state of the object.

In another aspect, the present disclosure relates to a method including obtaining, by a processor, a set of multimedia data feeds from a plurality of image capturing devices, wherein the set of multimedia data feeds correspond to a real-time event, and wherein the set of multimedia data feeds correspond to a time-series data captured at a plurality of time intervals and a multi-resolution data captured from the plurality of image capturing devices. The method includes processing, by the processor, the obtained set of multimedia data feeds using a plurality of model hyperparameters, wherein the plurality of hyperparameters comprise a frame rate, a domain specific semantic compression, a multimedia segment length, and overlap between multimedia segments. The method includes sequencing, by the processor, the processed set of multimedia data feeds in a predetermined order based on the time-series data and the multi-resolution data. The method includes obtaining, by the processor, at least one input prompt corresponding to the set of multimedia data feeds from at least one input source. The method includes generating, by the processor, an output representation of the real-time event by encoding the sequenced set of multimedia data feeds and the obtained at least one input prompt using a trained vision encoder model, wherein the generated output representation corresponds to a multi-resolution summary image of the real-time event at a time instance. The method includes predicting, by the processor, the predicted at least one action performed in the generated output representation using an action prediction model, wherein the at the at least one action includes at least one of an activity, a function, and a movement corresponding to the real-time event. The method includes outputting, by the processor, the predicted at least one action on a user interface of a user device.

In another aspect, the present disclosure relates to a non-transitory computer-readable medium including machine-executable instructions that may be executable by a processor to perform the method as discussed herein.

It is appreciated that method in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features of the present disclosure will be apparent from the description and drawings, and from the claims.

### BRIEF DESCRIPTION OF THE FIGURES

Various implementations in accordance with the present disclosure will be described with reference to the drawings, in which:

FIG. 1 depicts an example environment that may be used to execute implementations of the present disclosure.

FIG. 2 depicts an exemplary architecture of a system for summarization of a real-time event, in accordance with implementations of the present disclosure.

FIGS. 3A and 3B depict exemplary conceptual architectures of a summarizer, in accordance with implementations of the present disclosure.

FIG. 4 depicts an exemplary conceptual architecture of a training engine for training a vision encoder model, in accordance with implementations of the present disclosure.

FIG. 5 depicts an exemplary dataset selected for training of the vision encoder model, in accordance with implementations of the present disclosure.

FIGS. 6A and 6B depict exemplary illustrations of processing the dataset using a computer vision and an audio model, respectively, in accordance with implementations of the present disclosure.

FIG. 7 depicts an exemplary output/ground truth data, in accordance with implementations of the present disclosure.

FIG. 8 depicts an exemplary illustration of training the vision encoder model, in accordance with implementations of the present disclosure.

FIG. 9 depicts an example process flow of generating an output representation of the real-time event, in accordance with implementations of the present disclosure.

FIG. 10 depicts an exemplary description obtained for generating a highlight and an exemplary highlight generated for a sporting event, in accordance with implementations of the present disclosure.

FIGS. 11A and 11B depict exemplary illustrations of predicting one or more actions in the generated output representation of the real-time event, in accordance with implementations of the present disclosure.

FIG. 12 depicts an example process flow of detecting a state of an object in multimedia data feeds, in accordance with implementations of the present disclosure.

FIG. 13 depicts an exemplary video ingestion and search result, in accordance with implementations of the present disclosure.

FIG. 14 depicts an example process flow of performing processing of the multimedia data feeds and post-processing of the output representation of the real-time event corresponding to the multimedia data feeds, in accordance with implementations of the present disclosure.

FIG. 15 depicts an exemplary result of processing multimedia data feeds/video feeds, in accordance with implementations of the present disclosure.

FIGS. 16A and 16B depict exemplary results of evaluating the generated output representation/highlight of the real-time event, in accordance with implementations of the present disclosure.

FIG. 17 is a flow diagram that presents a method for summarization of the real-time event and prediction of the one or more actions in the summarized real-time event, in accordance with implementations of the present disclosure.

FIG. 18 depicts an example computer system, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” and/or the like, are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and/or the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the disclosure as set forth in the claims.

Implementations of the present disclosure generate a summary/output representation of a real-time event using a custom multi-modal model including a vision encoder model and an action prediction model. The summary of the real-time event is generated by encoding multimedia data feeds corresponding to the real-time event and one or more input prompts, using the vision encoder model. The multimedia data feeds are captured by different image capturing devices at different time intervals and from different angles/views, processed using appropriate processing models (including a computer vision model and an audio model), and sequenced in a predetermined order for the encoding.

Implementations of the present disclosure also predict one or more actions in the generated summary using the action prediction model and determine a state of an object in the multimedia data feeds.

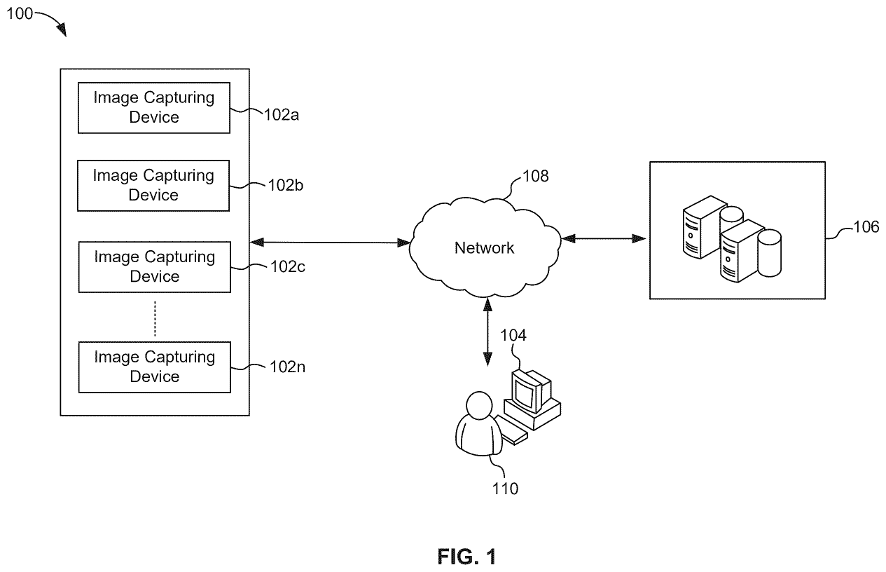

FIG. 1 depicts an example environment 100 that may be used to execute implementations of the present disclosure. In some examples, the example environment 100 enables generation of summaries of real-time events and prediction of one or more actions performed in the generated summaries.

As depicted in FIG. 1, the example environment 100 includes image capturing devices 102a-102n, a user device 104, and a system 106. The image capturing devices 102a-102n, the user device 104, and the system 106 may be communicatively coupled with each other using a network 108. In some examples, the network 108 may include, but is not limited to, a Local Area Network (LAN), a Wide Area Network (WAN), the Internet, or a combination thereof. In some other examples, the network 108 may be accessed over a wired and/or a wireless communication link.

The image capturing devices 102a-102n may capture a set of multimedia data feeds. Examples of the image capturing devices 102a-102n may include, but are not limited to, smartphones with cameras, wearable devices with cameras, Closed-Circuit Television (CCTV) systems, drones with cameras, mini camera devices, cameras embedded in a wide range of devices and equipment, dedicated camera systems, camcorders, dedicated surveillance cameras, Network Video Recorders (NVRs), Optical Character Recognition (OCR) systems, professional grade cameras, or a combination thereof. Examples of the set of multimedia data feeds may include, but are not limited to, text feeds, image feeds, video feeds, audio feeds, or a combination thereof. Therefore, the multimedia data feeds may include text data, image data, audio data, or a combination thereof.

The set of multimedia data feeds may correspond to a real-time event (e.g., a single event) captured by the image capturing devices 102a-102n from different angles/views. Further, the set of multimedia data feeds may correspond to time-series data of the real-time event captured at different time intervals and multi-resolution data captured by the image capturing devices 102a-102n. In some examples, the real time event may include, but is not limited to, a sporting event, a surveillance activity, a public safety monitoring activity, a conference, a corporate event, a concert, a reality show, a machinery operation, a logistic activity, a transportation activity, a customer action, a dealer action/performance, and/or the like. Examples of the sporting event may include, but are not limited to, baseball, soccer/football, cricket, tennis, car race, motorcycle race, skydiving, skiing, or any other similar sport. Examples of the transportation activity may include, but is not limited to, an arrival of a vehicle at an entry point, a positioning of the vehicle, deplaning, cleaning, onboarding, and/or the like. In an example herein, the vehicle may include an aircraft, a watercraft, a motor vehicle, and/or the like.

The user device 104 may be associated with a user 110. Examples of the user device 104 may include a desktop, smartphones, laptops, a tablet, voice-enabled devices, and/or the like. The user device 104 may provide one or more user interfaces (e.g., Graphical User Interfaces (GUIs)) that enable the user 110 to interact with the system 106 for an output representation of the real-time event corresponding to the multimedia data feeds. It should be noted that terms “output representation”, “summary”, “highlight” may be used interchangeably through the document. For example, the user device 104 may be used to provide input and/or receive output to/from the system 106. The input may include a request for generation of the summary/output representation and the output may include the summary/output representation.

In some examples, the system 106 (also be referred to as a summarization system) may be implemented as an on-premises system. In some other examples, the system 106 may be implemented as an off-premises system (for example, a cloud or an on-demand system). Additionally, or alternatively, the system 106 may be implemented in a cloud environment. For simplicity, the system 106 depicted in FIG. 1 may be a cloud environment that is intended to represent various forms of servers including a web server, an application server, a proxy server, a network server, a server pool, and/or the like.

The system 106 may obtain the multimedia data feeds from the image capturing devices 102a-102n and input prompts corresponding to the multimedia data feeds. Based on the multimedia data feeds and the input prompts, the system 106 may generate an output representation of the real-time event. The output representation of the real-time event may correspond to a multi-resolution summary image of the real-time event at a time instance. Further, the system 106 may predict one or more actions performed in the generated output representation. Examples of the one or more actions may include, but are not limited to, an activity, a function, a movement corresponding to the real-time event, and/or the like. In addition, the system 106 may identify a state of an object in the multimedia data feeds. In some examples, the state of the object may include a mental state and a physical state of the object.

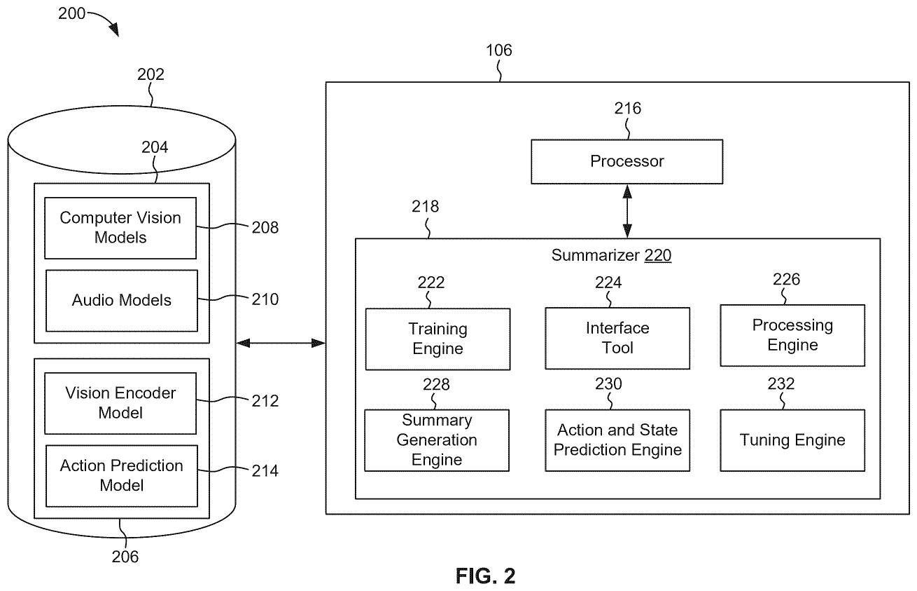

Various examples of generating the output representation of the real-time event and predicting the one or more actions and the state of the object in the multimedia data feeds are described in detail in conjunction with FIGS. 2-18.

FIG. 2 depicts an exemplary architecture 200 of the system 106 for summarization of the real-time event, in accordance with implementations of the present disclosure. As illustrated in FIG. 2, the system 106 may be communicatively coupled to a database 202. The database 202 includes processing models 204 and a custom multi-modal model 206.

The processing models 204 include computer vision models 208 and audio models 210. The computer vision models 208 may be used to perform one or more of: an object detection, an object tracking, a person detection, a person tracking, a semantic segmentation, a semantic compression, a multi-camera person recognition, and a multi-camera object recognition. Examples of the computer vision models 208 may include YoloV8 models (for performing the object detection and the object tracking), DeepSORT models (for performing the object tracking), image processing/correction models (for blur detection, CLAHE detection, and/or the like), DeepLabV3 models, Lightening-SAM models, TransRe-ID models, and so on. The audio models 210 may be used to perform one or more of: noise reduction, speech detection, and speech diarization. In some examples, the audio models 210 may include Artificial Intelligence (AI) models, Machine Learning (ML) models, and/or the like.

The custom multi-modal model 206 includes a vision encoder model 212 and an action prediction model 214. The vision encoder model 212 and the action prediction model 214 may be used for generation of the output representation of the real-time event and prediction of the one or more actions in the summarized real-time event, respectively. In some examples, the vision encoder model 212 and the action prediction model 214 may include Large Language Models (LLMs). While implementations of the present disclosure are described in further detail herein with non-limiting reference to the LLMs, it is contemplated that implementations of the present disclosure may be realized using any deep neural networks, Machine Learning (ML) models, or Artificial Intelligence (AI) models, or any other similar models. In some examples, the LLMs may be deployed on an edge hardware device (not shown in FIG. 2) and may have low latency.

Still referring to FIG. 2, the system 106 includes a processor 216 and a memory 218. The processor 216 may include one or more processors. Examples of the processor 216 may include but are not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. The processor 216 may be communicatively coupled with the memory 218. Further, the processor 216 may be configured to execute instructions (also referenced herein as processor-executable instructions) for performing operations according to the present disclosure. The memory 218 may be non-volatile or non-transitory computer-readable medium, such as a magnetic disk or solid-state non-volatile memory or volatile medium such as Random Access Memory (RAM), and/or the like.

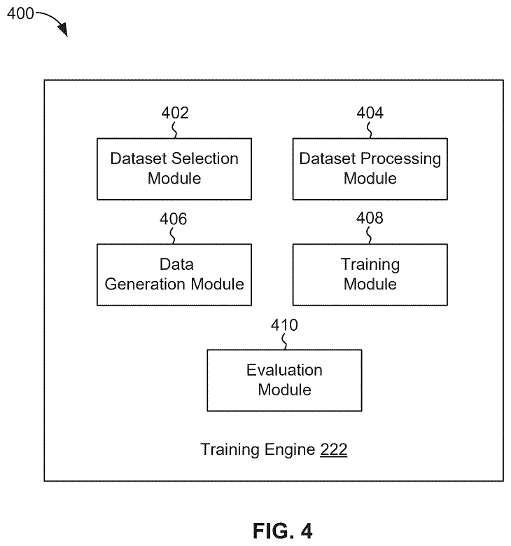

Further, the system 106 includes a summarizer 220. The summarizer 220 may be stored in the memory 218 and provided as a downloadable library including the instructions. The summarizer 220 includes a training engine 222. The training engine 222 may be executed by the processor 216 for training the vision encoder model 212, which is described in detail in conjunction with FIGS. 4-8.

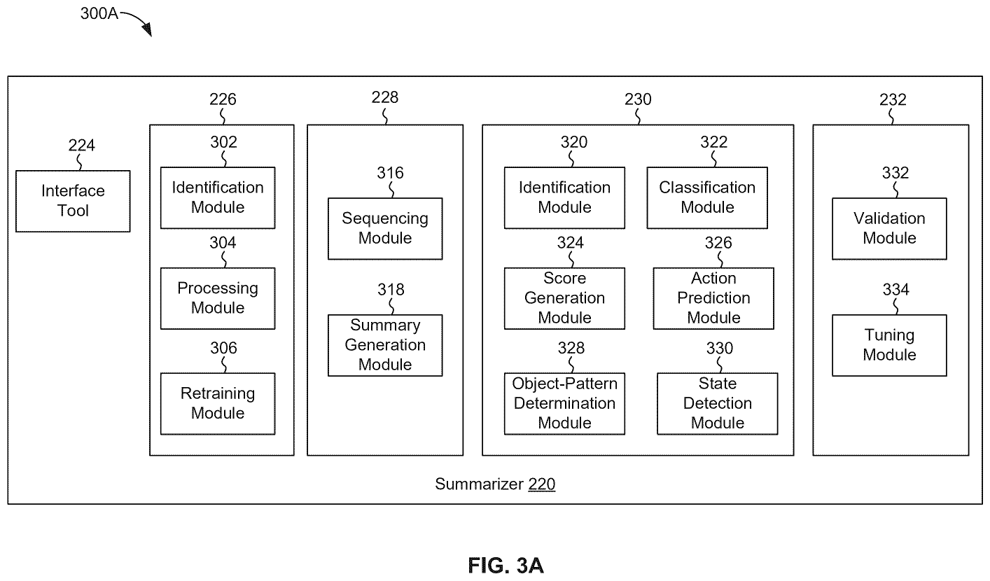

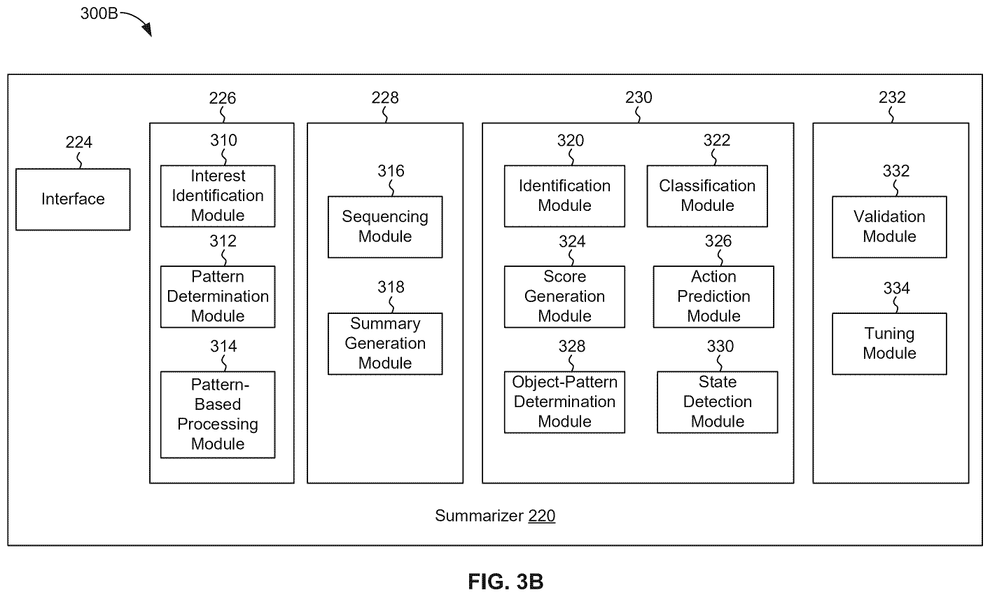

The summarizer 220 further includes an interface tool 224, a processing engine 226, a summary generation engine 228, an action and state prediction engine 230, and a tuning engine 232, which may be executed by the processor 216 to perform intended functions according to the present disclosure, which is further described in detail in conjunction with FIGS. 3A and 3B.

FIGS. 3A and 3B depict exemplary conceptual architectures 300A and 300B of the summarizer 220, respectively, in accordance with implementations of the present disclosure.

As depicted in FIGS. 3A and 3B, the interface tool 224 may obtain the set of multimedia data feeds from the image capturing devices 102a-102n. The set of multimedia data feeds may correspond to the real-time event. The set of multimedia data feeds may be captured by the image capturing devices 102a-102n at the different time intervals and with different resolution.

The interface tool 224 may also obtain the one or more input prompts corresponding to the set of multimedia data feeds from one or more input sources (not shown in FIGS. 3A and 3B). In some examples, an input source may include the user device 104. The one or more input prompts received from the user device 104 may include a user input. In some other examples, the input source may include a model (e.g., an LLM, an AI model, a ML model, and/or the like). The one or more input prompts obtained from the model may include a model input. The one or more input prompts may indicate a task/description for generating the output representation of the real-time event and/or actions of interest. For example, an input prompt may indicate a task of generating an output representation/highlight of a soccer match and actions of interest such as, goal scored, goal saved, celebrations, substitution, and/or the like.

The processing engine 226 may process the obtained set of multimedia data feeds. In some implementations, as depicted in FIG. 3A, the processing engine 226 includes an identification module 302, a processing module 304, and a retraining module 306.

The identification module 302 may identify a type of multimedia data included in the set of multimedia data feeds. The type of multimedia data may include text data, image data, audio data, and/or the like. The type of multimedia data may be identified by analyzing a file format, a data size, and contents of the multimedia data.

The identification module 302 may also identify one or more of: a type of objects, a position of objects, gestures performed within the set of multimedia data feeds, a text data, and an audio data using any of the computer vision models 208. The type of objects, the position of objects, and the gestures may vary based on the real-time event corresponding to the set of multimedia data feeds. In an example, consider a scenario where the real-time event includes a sporting event like football. In such a scenario, the type of objects may include players, referees, a ball, a goal post, and/or the like, the performed gestures may include scoring goals, penalty kicks, saving goals, celebrations, substitutions, and/or the like, the text data may include jersey numbers of the players, and the audio data may include a verbal communication between the referee and the players. In another example, consider a scenario where the real-time event includes a transportation activity related to an aircraft. In such a scenario, the type of objects may include the aircraft, a runway, an entry gate, and/or the like, the position of objects may include positioning of the aircraft (e.g., the aircraft is located at runway, or located at the entry gate, and/or the like), and the performed gestures may include arrival of the aircraft at the entry gate, deplaning, cleaning, boarding, and/or the like.

Based on the identified type of multimedia data, and the identified type of objects, the position of objects, the gestures performed within the obtained set of multimedia data feeds, the text data, and the audio data, the processing module 304 may select one or more of the appropriate processing models 204 for processing the set of multimedia data feeds. The selected one or more processing models may include one of the computer vision models 208, one of the audio models 210, or a combination thereof. In some examples, processing the set of multimedia data feeds using the computer vision model may include annotating the multimedia data feeds by performing one or more of: an object detection, an object tracking, a person detection, a person tracking, a semantic segmentation, a temporal compression, a semantic compression, a multi-camera person recognition, and a multi-camera object recognition on the set of multimedia data feeds. In some examples, processing the set of multimedia data feeds using the audio model may include detecting speakers in the set of multimedia data feeds and annotating the multimedia data feeds with speaker identifiers (IDs) corresponding to the detected speakers. The speakers may be detected by performing one or more of: noise reduction, speech diarization, and speech detection on the set of multimedia data feeds using the audio models 210.

By processing the set of multimedia data feeds, the processing module 304 may identify appropriate model hyperparameters for the vision encoder model 212. Examples of the model hyperparameters may include, but are not limited to, a frame rate, a resolution scale, a domain specific semantic compression, a multimedia segment length, and overlap between multimedia segments. Upon identifying the model hyperparameters, the retraining module 306 may retrain the vision encoder model 212 by tuning/fine-tuning the identified model hyperparameters.

In some other implementations, as depicted in FIG. 3B, the processing engine 226 includes an interest identification module 310, a pattern determination module 312, and a pattern-based processing module 314.

The interest identification module 310 may identify action(s) of interest within the set of multimedia data feeds. The action of interest may vary depending on the real-time event corresponding to the set of multimedia data feeds. In an example, if the real-time event includes a soccer game, the action of interest may include key game aspects such as team with possession of a ball, whether a play is in a box/near a goal, whether a goal scored, whether any key events have happened in a snippet, and/or the like. In another example, if the real-time event includes a public safety monitoring activity, the action of interest may include a person with dementia.

The pattern determination module 312 may determine patterns corresponding to the identified action of interest with respect to defined time instances/chunks. As a non-limiting example, the time instances may be defined as 10 seconds. The patterns may be determined by correlating each media frame with a subsequent media frame of the set of multimedia data feeds. In an example, if the action of interest includes whether the goal scored, the patterns may be determined by correlating media frames before and after a media frame identifying that the goal has been scored. In another example, if the action of interest includes the person with dementia, the patterns may include a dressing style of the person, a walking style of the person, and/or the like.

The pattern-based processing module 314 may process the obtained set of multimedia data feeds based on the determined patterns corresponding to the identified action of interests.

Once the set of multimedia data feeds are processed, the summary generation engine 228 may generate the output representation of the real-time event corresponding to the set of multimedia data feeds. The output representation may correspond to a multi-resolution summary image of the real-time event at a time instance. As depicted in FIGS. 3A and 3B, the summary generation engine 228 includes a sequencing module 316 and a summary generation module 318.

The sequencing module 316 may sequence the processed set of multimedia data feeds. The processed set of multimedia data feeds may be sequenced in a predetermined order based on the time-series data and the multi-resolution data. Sequencing the processed set of multimedia data feeds may provide time series information, which may ensure temporal information maintenance across the set of multimedia data feeds. Sequencing of the processed set of multimedia data feeds based on the multi-resolution data may provide information related to different angles/views of the real-time event. Therefore, by sequencing the processed set of multimedia data feeds, a relationship between the media frames in the multimedia data feeds may be determined and the real-time event may be analyzed from the different angles/views.

The summary generation module 318 may generate the output representation of the real-time event by encoding the sequenced set of multimedia data feeds and the obtained one or more input prompts using the trained vision encoder model 212. The trained vision encoder model 212 may include a computer vision encoder layer, a word embedding layer, and a Mixture of Experts (MoE) layer (including multiple sub-networks or experts).

For generating the output representation of the real-time event, the summary generation module 318 may encode the sequenced set of multimedia data feeds using the computer vision encoder layer. The summary generation module 318 may also encode the input prompt using the word embedding layer. Further, the summary generation module 318 may correlate the encoded set of multimedia data feeds with the encoded input prompt using the MoE layer to identify the action of interest. Based on the correlation, the summary generation module 318 may generate the output representation of the real-time event while indicating the action of interest. In an example, generating the output representation of the real-time event may include generating a highlight of a sporting event for the action of interest like goal scored or goal saved, or penalty kicks, or goal missed, and/or the like. In another example, generating the output representation of the real-time event may include generating a highlight of turnaround of an aircraft at a gate. In yet another example, generating the output representation of the real-time event may include generating summary of a surveillance activity for the action of interest like security and operations. In yet another example, generating the output representation of the real-time event may include generating a highlight of a public safety monitoring event, wherein the highlight includes an image for the action of interest like a person with dementia. As would be understood, implementation of the present disclosure may not be limited to the above-described examples, it may include other examples including the above-described examples.

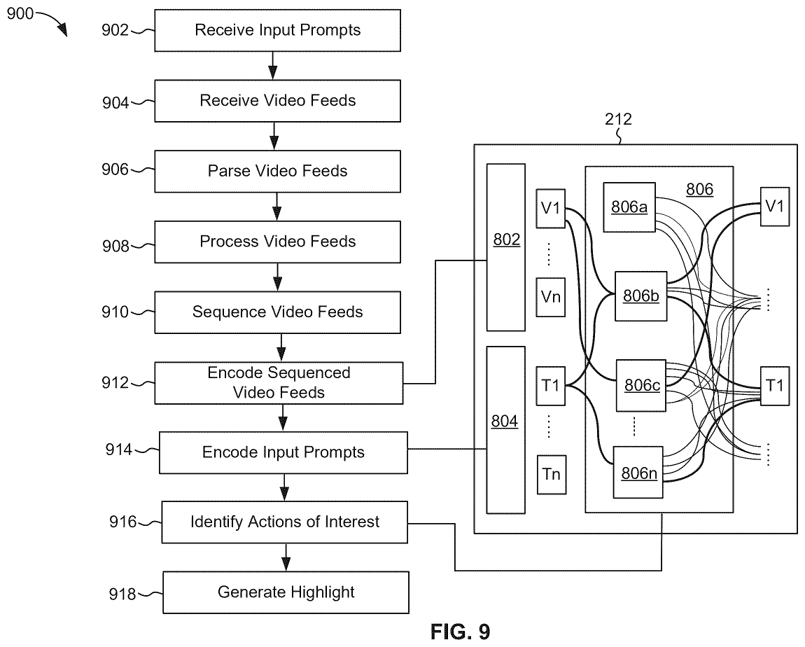

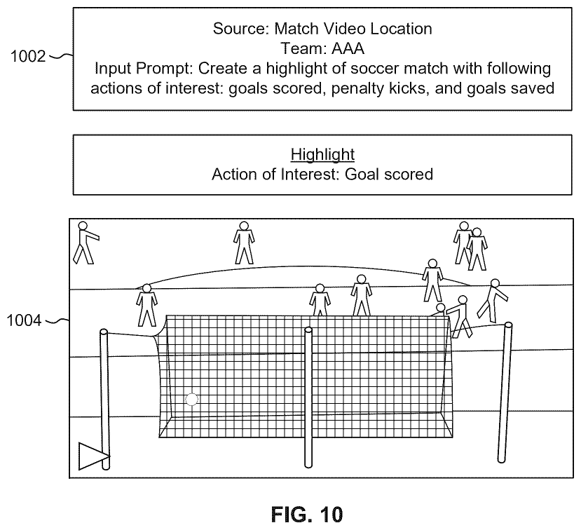

The output representation of the real-time event may be used for different purposes such as, but are not limited to, capturing essence of the sporting event, tracing the person/object, identifying anomalous operations, and/or the like. An exemplary illustration of generating the output representation of the real-time event is described in detail in conjunction with FIGS. 9 and 10.

The action and state prediction engine 230 may predict the one or more actions performed in the generated output representation. As depicted in FIGS. 3A and 3B, the action and state prediction engine 230 includes an identification module 320, a classification module 322, a score generation module 324, and an action prediction module 326.

The identification module 320 may identify one or more of: a type of objects, a position of objects, gestures performed within the obtained set of multimedia data feeds using the computer vision model. Based on the identified type of objects, the position of objects, the gestures performed within the set of multimedia data feeds, the classification module 322 may classify the set of multimedia data feeds into domain specific events. The domain specific events may indicate actions that may be expected in the real-time event. In an example, if the real-time event includes a soccer match, the domain specific events may include goal scored, goal missed, goal saved, passing ball, and/or the like. In another example, if the real-time event includes monitoring of aircraft activity, the domain specific events may include arrival of the aircraft, cleaning, onboarding, deplaning, and/or the like. The score generation module 324 may generate confidence scores for the domain specific events using the action prediction model 214.

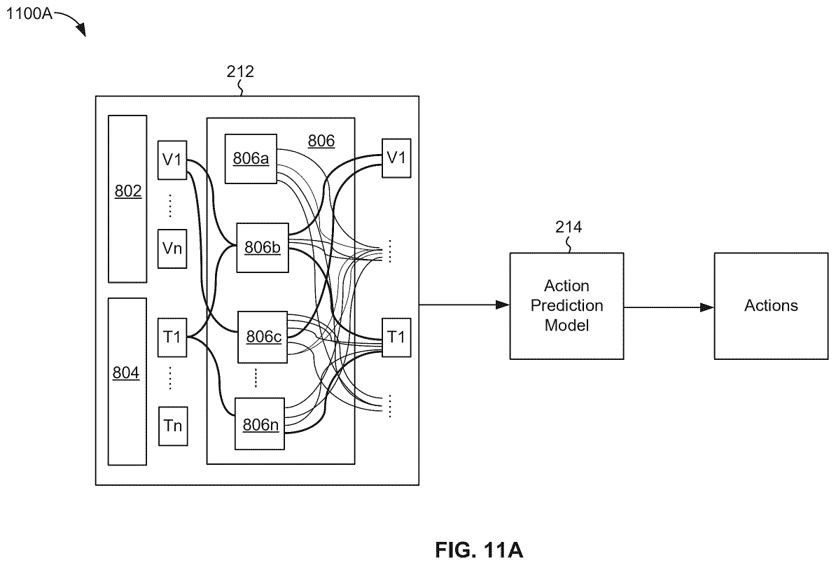

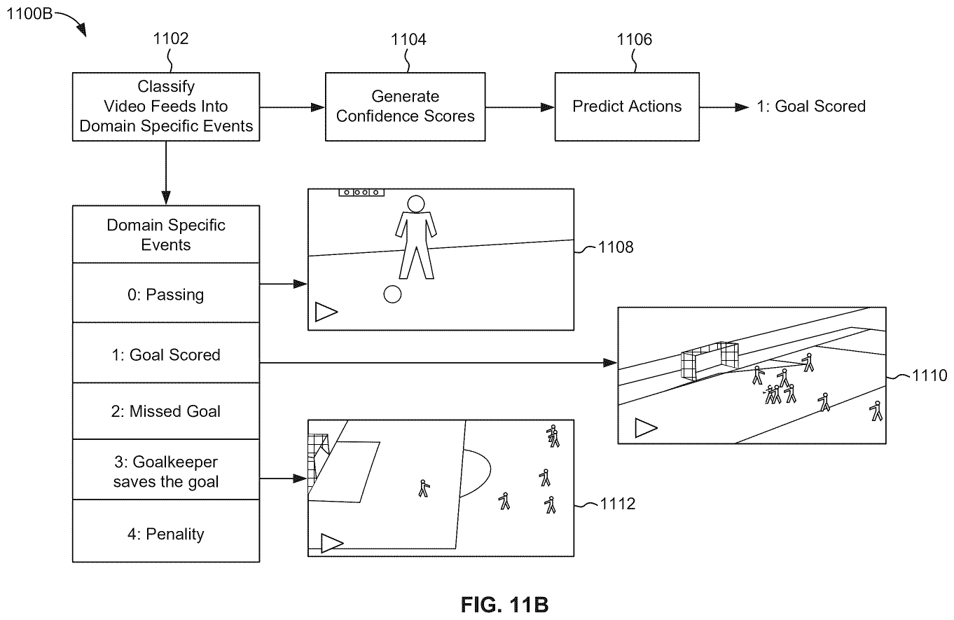

The action prediction module 326 may predict the one or more actions performed in the generated output representation using the generated confidence scores. In an example, the domain specific event like goal saved may be predicted as the action performed in a highlight of the soccer game, when the goal saved is associated with the highest confidence score among the other domain specific events related to the soccer match. In another example, the domain specific event like onboarding may be predicted as the action performed in a highlight of turnaround of the aircraft, when the onboarding is associated with the highest confidence score among the other domain specific events related to the monitoring of aircraft activity. Exemplary illustrations of predicting the one or more actions performed in the output representation is described in detail in conjunction with FIGS. 11A and 11B.

The action and state prediction engine 230 may also detect a state of one or more objects within the obtained set of multimedia data feeds. As depicted in FIGS. 3A and 3B, the action and state prediction engine 230 further includes an object-pattern determination module 328, and a state detection module 330.

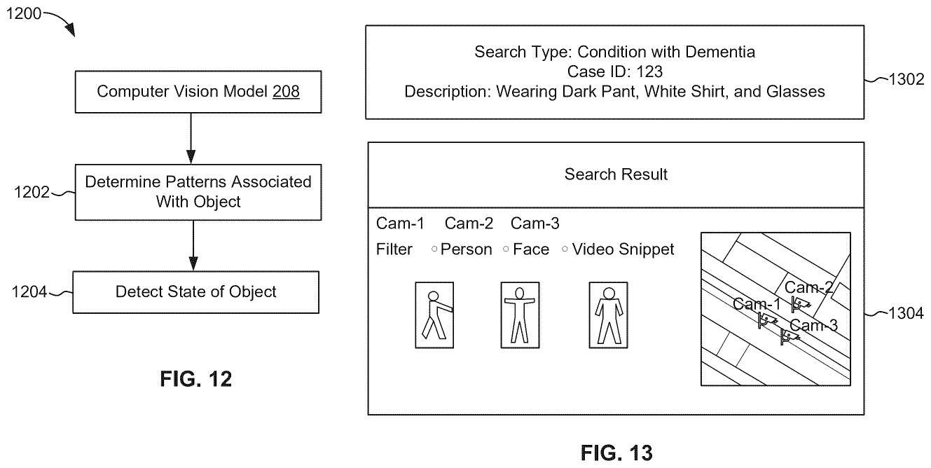

The object-pattern determination module 328 may determine one or more patterns with the one or more objects within the obtained set of multimedia data feeds using the trained vision encoder model. The state detection module 330 may detect the state of the one or more objects within the obtained set of multimedia data feeds based on the determined one or more associated patterns. The state of each of the one or more objects may include a mental state and a physical state of the object. An exemplary illustration of detecting the state of the object in the multimedia data feeds is described in FIG. 12.

The interface tool 224 may output the predicted one or more actions and/or the state of the object on the user interface of the user device 104.

The tuning engine 232 may tune the action prediction model 214 based on the predicted one or more actions. As depicted in FIGS. 3A and 3B, the tuning engine 232 includes a validation module 332 and a tuning module 334.

The validation module 332 may validate a model performance of the action prediction model 214. The model performance of the action prediction model 214 may be associated with prediction of the one or more actions in the generated output representation of the real-time event. The model performance of the action prediction model 214 may be validated based on key performance factors. The key performance factors may depict accuracy, latency, and model characteristics of the action prediction model 214 such as, but are not limited to, a data sensitivity factor, a data specificity factor, a ground truth level of the action prediction model 214, and so on. The ground truth level of the action prediction model 214 may identify portions of the multimedia data feeds used to generate the output representation of the real-time event.

The tuning module 334 may tune the action prediction model 214 to generate one or more updated actions based on results of the validation. In some examples, tuning of the action prediction model 214 may include updating weights of the action prediction model 214. Further, the tuning module 334 may generate periodic instructions for fine tuning of the action prediction model 214.

FIG. 4 depicts an exemplary conceptual architecture 400 of the training engine 222 for training the vision encoder model 212, in accordance with implementations of the present disclosure. The training engine 222 may perform domain-adapted training of the vision encoder model 212. For example, the training engine 222 may use a dataset related to a specific event for training the vision encoder model 212, so that the vision encoder model 212 may be used to generate the output representation of the respective event in real-time with high accuracy. Due to the domain-adapted training, the vision encoder model 212 may be used for the different real-time events across the different domain/industries. Alternatively, or additionally, the training engine 222 may allow the user 110 to customize training of the vision encoder model 212 for a given event/domain, which may further enhance accuracy and reduce latency of the vision encoder model 212. The training of the vision encoder model 212 may be customized through use of customized model hyperparameters such as frame rate, semantic compression, or the like to reduce token length while ensuring high accuracy. Therefore, the vision encoder model 212 may be used for real-time use with improved latency and accuracy and reduced probability of hallucination.

As depicted in FIG. 4, the training engine 222 includes a dataset selection module 402, a dataset processing module 404, a data generation module 406, a training module 408, and an evaluation module 410.

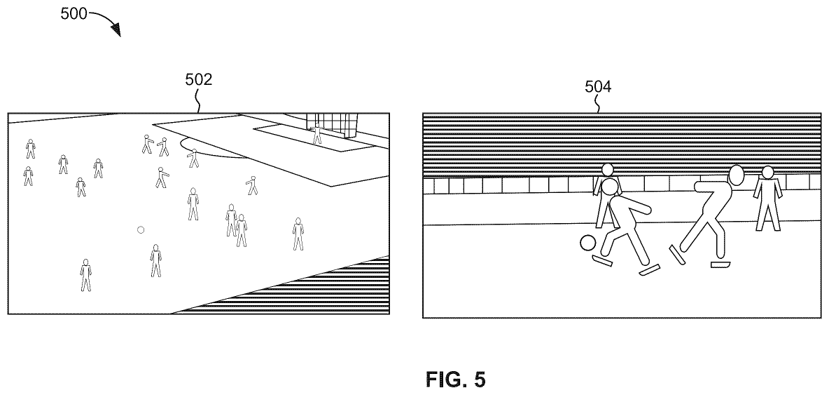

The dataset selection module 402 may obtain datasets from different data sources (not shown) and selects an appropriate dataset from the obtained datasets for training of the vision encoder model 212. The dataset may correspond to one of the previously organized events. The dataset may include multiple exemplary multimedia data feeds corresponding to the previously organized event. The multimedia data feeds may be captured by the different image capturing devices 102a-102n with different resolution. The multimedia data feeds in the dataset selected for training may ensure that the vision encoder model 212 may be used across relevant variations in the event. The multimedia data feeds may include long form of video content, multiple media frames, and/or the like. By way of non-limiting example, the multimedia data feeds for a sporting event like soccer match may include players of different teams (to account for change in jersey colors), a soccer field/ground, stadium, and so on. An exemplary dataset 500 selected for training is illustrated in FIG. 5. The exemplary dataset 500 includes media frames 502 and 504 identifying a stadium and players of different teams, respectively.

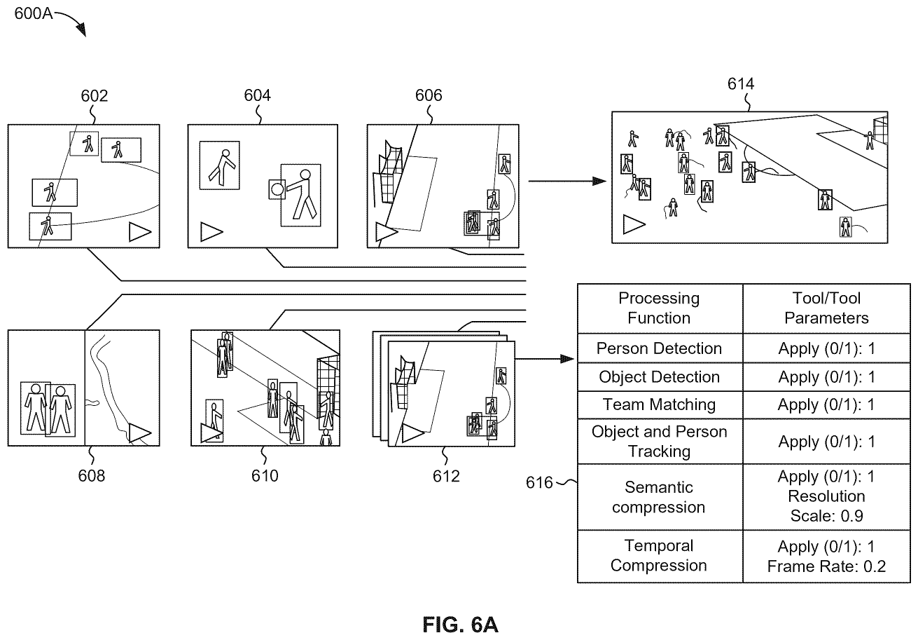

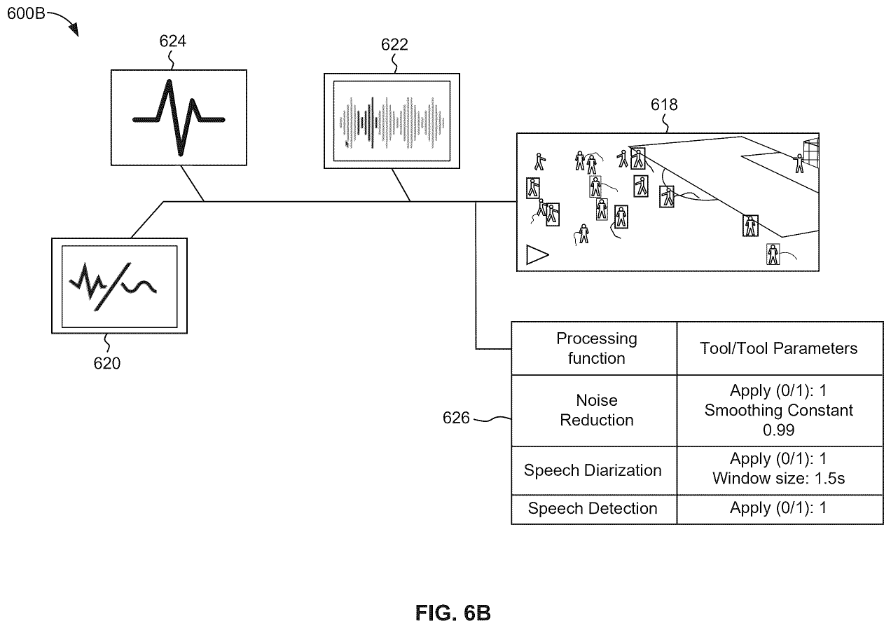

The dataset processing module 404 may select the appropriate processing models 204 for processing the dataset selected for training of the vision encoder model 212. Processing of the dataset may include chunking the multimedia data feeds (e.g., forming chunks of the multimedia data feeds) for each of the image capturing devices 102a-102n based on a frame rate and a segment length and processing the chunks of the multimedia data feeds using the selected appropriate processing models 204. The processing models 204 may include the computer vision model 208 and the audio model 210. Exemplary illustrations 600A and 600B of processing the dataset using the computer vision model 208 and the audio model 210 are depicted in FIGS. 6A and 6B, respectively.

As depicted in FIG. 6A, consider that the selected dataset includes multiple video feeds/snippets. In such a scenario, the dataset processing module 404 may generate a processed video by performing processing functions on the video feeds using the computer vision model 208. The processing functions include person detection 602, object detection 604, semantic compression 606, person tracking 608, object tracking 610, and temporal compression 612. The processed video includes an annotated video 614.

By performing the processing functions 602-612 on the video feeds, the dataset processing module 404 may further identify the appropriate model hyperparameters for training of the vision encoder model 212. In some implementations, the model hyperparameters may include a tool and tool parameters. The tool (0/1) may be selected to turn ON or OFF during training of the vision encoder model 212. For example, based on the processing functions 602-612 performed on the video feeds, the tool may be turned ON or OFF. The tool parameters include a frame rate, a resolution rate, a domain specific semantic compression, a multimedia segment length, and overlap between multimedia segments. Each of the tool parameters may be set between 0 and 1 during training of the vision encoder model 212. For example, based on the semantic compression 606, the tool parameter like the resolution rate may be set as 0.5 (e.g., reducing the resolution rate to 50% of an original). For another example, based on the temporal compression 612, the tool parameter like the frame rate may be set as 0.2 (e.g., reducing the frame rate to 80% of an original). An exemplary table 616 indicating the processing functions and the tool and the tool parameter identified based on the processing functions is illustrated in FIG. 6A.

As depicted in FIG. 6B, consider that the selected dataset includes multiple video feeds. In such a scenario, the dataset processing module 404 may generate a processed video 618. The processed video 618 may include an annotated video with annotated speakers. For generating the processed video 618, the dataset processing module 404 may perform processing functions on the video feeds using the audio model 210. The processing functions performed using the audio model 210 may include noise reduction 620, speech diarization 622, and speech detection 624. After performing the processing functions 620-624, the dataset processing module 404 may identify speakers across the video feeds, generate speaker identifiers (IDs) for the speakers, and annotate the speaker IDs on the video feeds.

By performing the processing functions 620-624 on the video feeds, the dataset processing module 404 may further identify the appropriate model hyperparameters for training of the vision encoder model 212. In some implementations, the model hyperparameters may include a tool and tool parameters. The tool (0/1) may be selected to turn ON or OFF during training of the vision encoder model 212. For example, based on the processing functions 620-624 performed on the video feeds, the tool may be turned ON or OFF. The tool parameters include a smoothing constant/spectral subtraction hyperparameter, a window size, and/or the like. In an example, the smoothing constant may be set from 0.9 to 0.99 based on the noise reduction 620 performed on the video feeds and the window size may be set in seconds (e.g., 1.5 seconds) based on the speech diarization 622 performed on the video feeds. An exemplary table 626 indicating the processing functions 620-624 and the tool and the tool parameter identified based on the processing functions 620-624 is illustrated in FIG. 6B.

Processing of the selected dataset/video feeds using the computer vision model 208 and audio model 210 may reduce latency, improve repeatability and reduce hallucination of the vision encoder model 212. For example, generating the annotated dataset/video feeds by performing the processing functions 602 and 604 using the computer vision model 208 (as illustrated in FIG. 6A) and performing the processing functions 622 and 624 (as illustrated in FIG. 6B) using the audio model 210 may aid in improving the repeatability and reducing the hallucination of the vision encoder model 212. Setting the tool parameters based on the processing functions 606 and 612 may reduce the latency of the vision encoder model 212. In addition, performing the processing functions 620-624 for pre-identifying segments mapped to key speakers and events may reduce the latency of the vision encoder model 212.

Referring back to FIG. 4, the data generation module 406 may generate a ground truth data for the vision encoder model 212. The ground truth data may indicate actions of interest and output representation of the event within the processed dataset and actions of interest, which are expected to be generated using the vision encoder model 212.

For example, consider a scenario where the processed dataset includes video feeds related to a sporting event. In such a scenario, the ground truth data may include a task, instructions, and an output. In some examples, the task may provide an indication to process the video feeds to identify actions of interest.

In some examples, the instructions may include a possession team, a type of an activity, a location of the activity, gestures performed within the video feeds, and/or the like. The possession team may refer to a team in possession of a ball. The team in possession of the ball may be identified by performing the person detection on the video feeds using the computer vision model. For example, teams like “team A” and “team B” may be identified based on the person detection and matching color of jersey with the “team A” and the “team B”. To illustrate, players wearing jersey of red color are grouped as the “team A” and players wearing jersey of blue color are grouped as the “team B”. Players wearing the jersey of neither red color nor blue color may be grouped as “None”. Based on the detection of the “team A” and the “team B”, the team in possession of the ball may be identified. The type of the activity may set to “goal”, “save”, “caught”, “penalty”, “corner kicks”, “foul”, “pass”, “block”, “shot”, “cleared”, “dribble”, “none”, “no goal”, “wide shot”, “corner kick setup”, “penalty setup” and so on. The type of the activity may be set based on the activity observed in the video feeds. The location of activity may be a region in the video feeds, where the activity had been performed. The location may include “center circle”, “corners”, “goal area”, “penalty area”, “goal line”, “touchline”, “mid field”, or “None” based on a context of the video feeds. The gestures may include celebration, substitution, and so on. A status of celebration may be turned ON if the players in the video feeds are celebrating. A status of substitution may be turned ON if player substitution occurs in the video feeds.

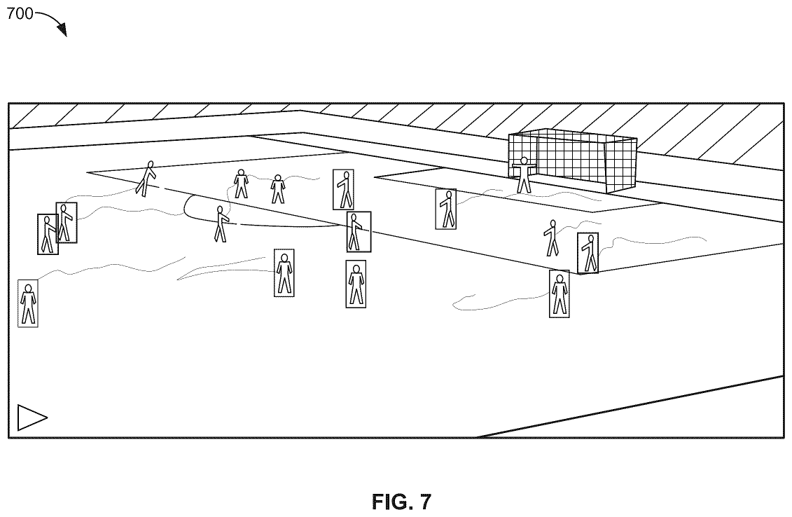

The output may include a video feed/snippet summarized for the video feeds in the processed dataset and description for the video feed. The description for the video feed may indicate the actions of interest, for example, the team in the possession of the ball, the activity performed in the video feed (e.g., goal saved (“save”)), the location of the activity (e.g., “penalty area”), the gestures (e.g., the status of celebration: “FALSE”, the status of substitution: “FALSE”), and so on. An exemplary output/ground truth data including a video feed 700 is depicted in FIG. 7.

The data generation module 406 may also generate one or more training prompts. The one or more training prompts may include the instructions (as described above).

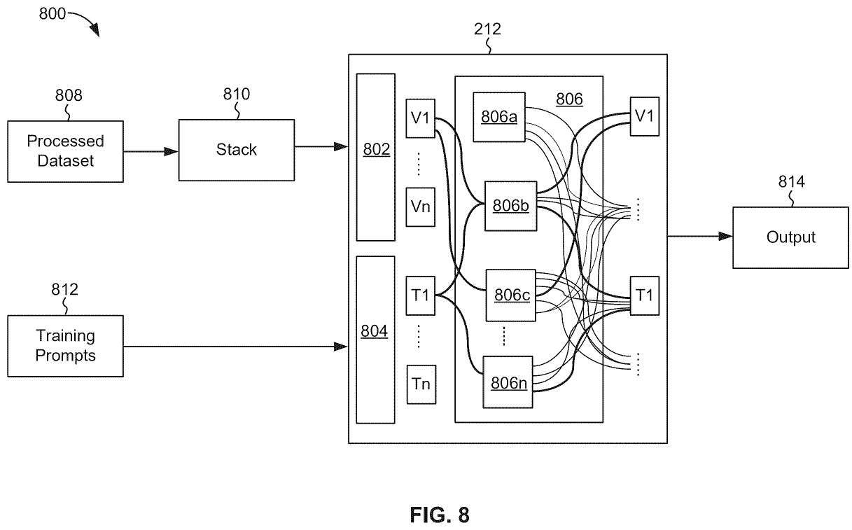

The training module 408 may train the vision encoder model 212 based on the processed dataset, the one or more training prompts, and the ground-truth data. In some examples, the training module 408 may use Low-Rank Adaption (LoRA) methods for training of the vision encoder module 212, which may further reduce a number of the model hyperparameters that requires to be trained and may align the vision encoder model 212 to the specific event related to the processed data. The LoRA methods may be used based on a loss function associated with the vision encoder model 212. An exemplary illustration 800 of training the vision encoder model 212 is illustrated in FIG. 8. As depicted in FIG. 8, the vision encoder model 212 includes a computer vision encoder layer 802, a word embedding layer 804, and a MoE layer 806. The MoE layer 806 includes separate sub-networks or experts 806a-806n.

As depicted in FIG. 8, for training the vision encoder model 212, the training module 408 may obtain the processed dataset 808 and form a stack 810. The stack 810 may include the multimedia data feeds (of the processed dataset) sequenced/arranged in a predetermined order. Therefore, temporal information and multi-resolution data may be maintained across the set of multimedia data feeds. The training module 408 may use the computer vision encoder layer 802 to generate an encoded set of multimedia data feeds (V₁ . . . Vₙ) by processing the formed stack 810. Similarly, the training module 408 may use the word embedding layer 804 to generate encoded prompts (T₁ . . . Tₙ) by processing the one or more training prompts 812.

The encoded set of multimedia data feeds (V₁ . . . Vₙ) and the encoded prompts (T₁ . . . Tₙ) may be correlated to identify the actions of interest using the experts 806a-806n of the MoE layer 806. The actions of interest may be used to generate the output representation (V₁ . . . T₁ . . . ) of the event corresponding to the processed dataset. The action of interest and output representation of the event may form an output 814 of training the vision encoder module 212.

Advantageously, performing the domain-adapted training of the vision encoder model 212 using the processed dataset, the model hyper-parameters and encoding steps may reduce latency and optimize accuracy of the vision encoder model 212. For example, for generating the output representation/highlight of a sporting event, the model hyperparameters may include the semantic compression for different views of the image capturing devices 102a-102n, a length of the multimedia data feeds for classification, a model size, and the input prompt for the classification/summarization.

Referring back to FIG. 4, the evaluation module 410 may perform a comparison/matching of the output 814 (of training the vision encoder module 212) with the ground truth data (generated by the data generation module 406). Based on the comparison, the evaluation module 410 may assign an accuracy score/weight for the output 814. The accuracy score may measure accuracy of the output 814. For example, the accuracy score may be assigned for the output 814 based on comparison with the ground truth data for the action of interest such as the team in the possession of the ball (% identified vs actual match), the activity, the location, and the gestures (% identified vs actual match), and latency (e.g., time taken for generating the output).

The evaluation module 410 may also identify subsequent model hyperparameters for tuning based on the accuracy score. In some examples, the evaluation module 410 may perform a Bayesian hyper parameter search (e.g., Tree Structured Parzen Estimator Gradient) to select the appropriate processing models 204 to identify the subsequent model hyperparameters based on the accuracy score.

FIG. 9 depicts an example process flow 900 of generating the output representation of the real-time event, in accordance with implementations of the present disclosure. By way of a non-limiting example, consider that the real-time event includes a soccer match.

As illustrated in FIG. 9, the interface tool 224 receives 902 input prompts. In an example herein, the input prompts include user prompts received from the user device 104 of the user. The user prompts may indicate a task for creating a highlight/output representation of the soccer match and actions of interest such as goal scored, penalty kicks, and goals saved. The interface tool 224 also receives 904 video feeds (e.g., the multimedia data feeds) corresponding to the soccer match. The video feeds may be captured by the different image capturing devices 102a-102n at different time intervals and with multiple resolutions.

Upon receiving the video feeds, the processing engine 226 parses 906 each of the video feeds at 1 frame per second (fps), thereby preparing a batch of video feeds across 10 seconds for generating the highlight. The processing engine 226 further processes 908 the video feeds using the appropriate processing models 204. Processing of the video feeds may include a domain specific semantic compression to reduce token size (e.g., by 2×) and latency. Additionally, or alternatively, processing of the video feeds may include optimizing a frame rate, an overlap between segments/frames of the video feeds, a length of the segments/frames of the video feeds, and so on. Further, processing of the video feeds may be followed by retraining of the vision encoder model 212. The vision encoder model 212 may be retrained/fine-tuned by tuning weights or the model hyperparameters. In an example herein, the vision encoder model 212 may include a quantized 7B parameter model with 35 layers, so that the summarization of the soccer match may be parallelized on a larger compute instance.

After processing the video feeds, the summary generation engine 228 sequences 910 the frames of the video feeds in the pre-determined order. Further, the summary generation engine 228 encodes 912 the sequenced video feeds using the computer vision encoder layer 802 of the vision encoder model 212. Encoding the sequenced video feeds may include generating embeddings/vector representations for the sequenced video feeds. Advantageously, through the use of the computer vision encoder layer 802, temporal information/patterns in the video feeds may be processed by determining a relationship between subsequent videoframes/segments of the video feeds. In addition to the temporal information, there exits multiple views of the soccer match/event (e.g., a zoomed-in view, a zoomed-out view, and/or the like), as the video feeds of the soccer match are captured using the image capturing devices 102a-102n. Therefore, encoding the sequenced video feeds using the computer vision encoder layer 802 may enable to understand the real-time event/soccer match across the multiple views.

The summary generation engine 228 also encodes 914 the input prompts using the word embedding layer 804 of the vision encoder model 212. Upon encoding the sequenced video feeds and the input prompts, the summary generation engine 228 identifies 916 the actions of interest. The actions of interest may be identified by correlating the encoded sequenced video feeds with the encoded input prompts using the experts 806a-806n of the MoE layer 806. In an example herein, the identified actions of interest may include goals scored. Further, the summary generation engine 228 generates 918 the highlight of the soccer match including the actions of interest like goal scored. An exemplary description 1002 (e.g., including source of video feeds related to soccer match, a team, an input prompt, or the like) for generating a highlight of a soccer match and an exemplary highlight 1004 of the soccer match generated for the goal scored is depicted in FIG. 10. The exemplary highlight 1002 may include a short-framed video feed.

In some implementations, the processing engine 226 may perform post processing of the generated highlight. Post processing may include de-duplicating the video feeds and generating a new highlight based on the video feeds where the actions of interest are observed.

FIG. 11A depicts an example illustration 1100A of predicting the one or more actions in the generated output representation of the real-time event, in accordance with implementations of the present disclosure.

The action and state prediction engine 230 obtains the output representation of the real-time event generated using the vision encoder model 212. Further, the action and state prediction engine 230 processes the output representation of the real-time event using the action prediction model 214 to predict the one or more actions in the generated output representation. An exemplary process flow 1100B of predicting the one or more actions using the action prediction model 214 is depicted in FIG. 11B. By way of a non-limiting example, consider that the real-time event includes a soccer match, and the output representation includes a highlight of the soccer match. The highlight includes shorter video feeds.

As depicted in FIG. 11B, the action and state prediction engine 230 classifies 1102 the video feeds in the generated highlight into domain specific events. The domain specific events may be referred to actions that may be performed in the soccer match, for example, passing ball (0), goal scored (1), missed goal (2), goalkeeper saves the goal (3), and penalty (4), as depicted in FIG. 11B. Exemplary video feeds 1108, 1110, and 1112 including the respective domain specific events such as passing ball (0), goal scored (1), and goalkeeper saves the goal (3) are depicted in FIG. 11B.

Once the video feeds are classified, the action and state prediction engine 230 generates 1104 the confidence scores for the domain specific events. For example, the confidence scores of 90, 95, 80, 90, and 85 may be generated for the domain specific events such as passing ball (0), goal scored (1), missed goal (2), goalkeeper saves the goal (3), and penalty (4), respectively.

Based on the generated confidence scores, the action and state prediction engine 230 predicts 1106 the one or more actions performed in the generated highlight. The action and state prediction engine 230 may predict the domain specific event(s) with the highest confidence score as the action performed in the generated highlight. In an example herein, the action and state prediction engine 230 may predict the goal scored (1) as the action, as the goal scored (1) is associated with the highest confidence score of 95.

FIG. 12 depicts an example process flow 1200 of detecting the state of the object in the multimedia data feeds, in accordance with implementations of the present disclosure.

As illustrated in FIG. 12, the action and state prediction engine 230 determines 1202 one or more patterns associated with the object within the set of multimedia data feeds. The one or more patterns associated with the object may be determined using the trained vision encoder model. The one or more patterns may provide description associated with the object.

Based on the determined one or more patterns, the action and state prediction engine 230 detects 1204 the state of the object. In some examples, the state of the object may be detected for tracking or tracing applications. The state of the object may include a mental state and a physical state of the object. For example, consider a scenario where a person is required to be tracked. In such a scenario, the action and state prediction engine 230 obtains the multimedia data feeds including the person, determines the patterns (e.g., movements, behavior, or the like) associated with the person, and accordingly detects the state of the person. For example, the state of the person may indicate that the person is suffering from dementia and the person is wearing dark pants, white shirts, and glasses.

In some implementations, as depicted in FIG. 13, the summary generation engine 228 may receive a request 1302 for tracking of a person. The request 1302 may indicate a search type indicating the state of the person (e.g., condition with dementia), a case ID, and a description indicating a dressing style of the person. Based on the request 1302, the summary generation engine 228 may generate the output representation 1304 of the multimedia data feeds (captured using the image capturing devices 102a-102n, for example herein, a camera 1 (cam 1)) including the person, as depicted in FIG. 13. The output representation 1304 may include images of the person.

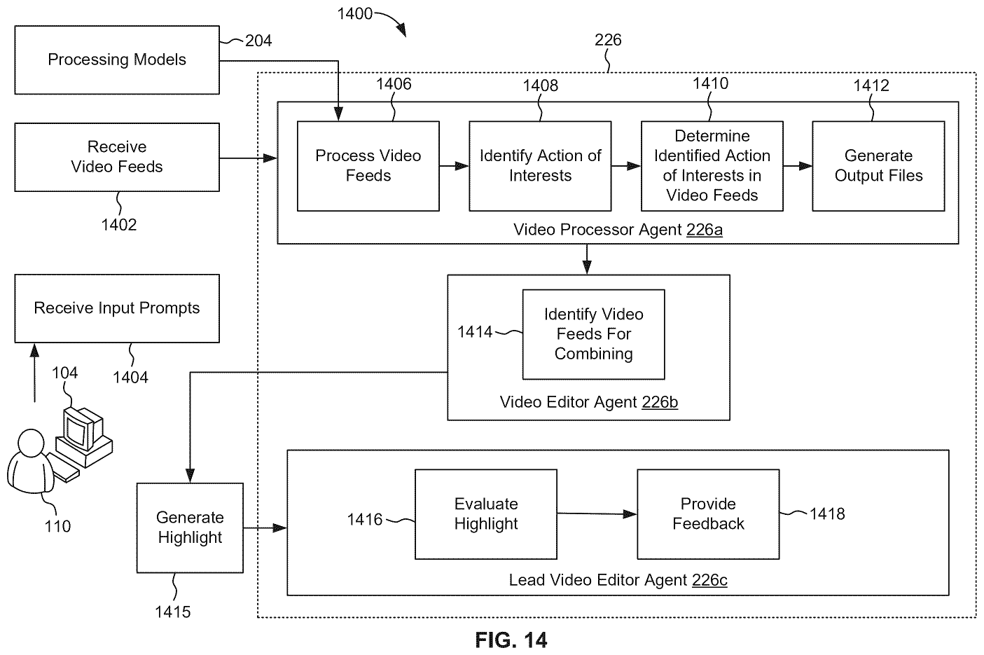

FIG. 14 depicts an example process flow 1400 of performing processing of the multimedia data feeds and post-processing of the output representation of the real-time event corresponding to the multimedia data feeds, in accordance with implementation of the present disclosure. By way of a non-limiting example, consider that the real-time event includes a soccer match, and the multimedia data feeds include video feeds.

As depicted in FIG. 14, the interface tool 224 receives 1402 the video feeds related to the soccer match from the image capturing devices 102a-102n and receives 1404 input prompts from the user device 104. The input prompts may indicate a task/description for generating a highlight (summary/output representation) of the soccer game. In some examples, the input prompt may also indicate actions of interest/key game aspects such as team with possession of a ball, an activity like goal saved, a location/area of the activity, gestures such as celebration, foul, substitution, or the like.

After receiving the video feeds and the input prompts, the processing engine 226 may be enabled to operate. In an example illustrated in FIG. 14, the processing engine 226 may act as a processor agent 226a for processing the video feeds, a video editor agent 226b to identify the appropriate video feeds for generating the highlight of the soccer match, and a lead video editor agent 226c to review the generated highlight.

The processing engine 226 (acting as the processor agent 226a) processes 1406 the video feeds in defined time intervals/chunks (e.g., 10 seconds). The processing engine 226 may use the appropriate processing models 204 such as the computer vision models 208 and the audio models 210 for processing the video feeds. For example, using the computer vision models 208, the processing engine 226 may perform person detection to detect players of teams based on color of jersey wearing by the players, object detection to detect objects such as ball, goal corner, and/or the like, person and object tracking to track a movement of the players and the objects, semantic compression to modify resolution rate, temporal compression to modify frame rate, and so on. Similarly, using the audio models 210, the processing engine 226 may perform speech detection, noise reduction, and speech diarization.

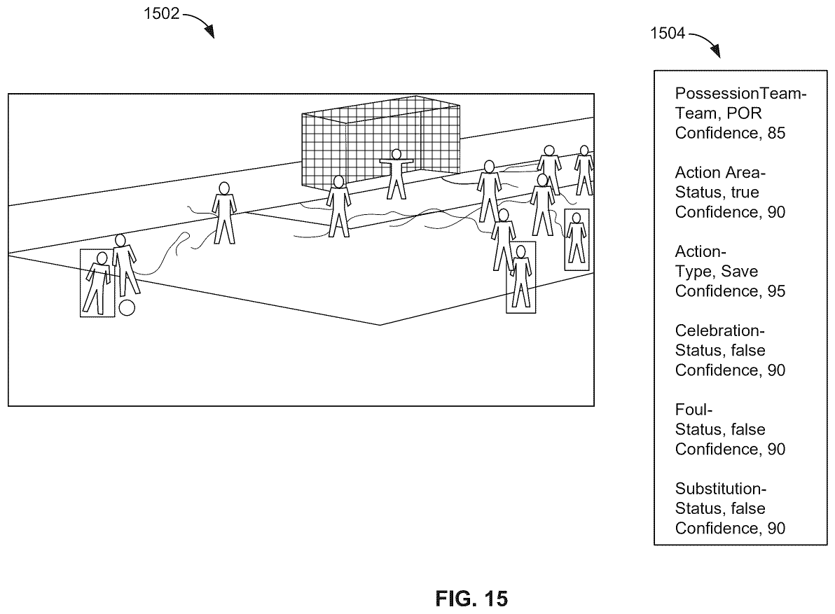

Based on the processing of the video feeds, the processing engine 226 identifies 1408 the actions of interest and determines 1410 the actions of interest performed in the video feeds. The processing engine 226 generates 1412 output files (e.g., json files) for the video feeds based on the determination of the actions of interest in the video feeds. A json file may indicate the actions of interest associated with the respective json file. In some examples, the processing engine 226 generates a confidence score for each of the identified actions of interest. An exemplary result of processing the video feeds indicating the actions of interest 1502 and the associated confidence scores 1504 is depicted in FIG. 15.

Further, the processing engine 226 (acting as the video editor agent 226b) obtains the json files of the video feeds and identifies 1414 which video feeds need to be combined for generating the highlight. The processing engine 226 may identify the video feeds for combining based on the identified actions of interest. For example, if goal is scored in a video feed 172, the processing engine 226 considers the video feeds before 172 to identify chunks that include a development of game near a box or goal and considers chunks after the goal is scored that include celebration. The identified video feeds may be further edited 1415 into the highlight (e.g., a shorter video format) using the vision encoder model 212. The highlight may capture the essence of the entire soccer match.

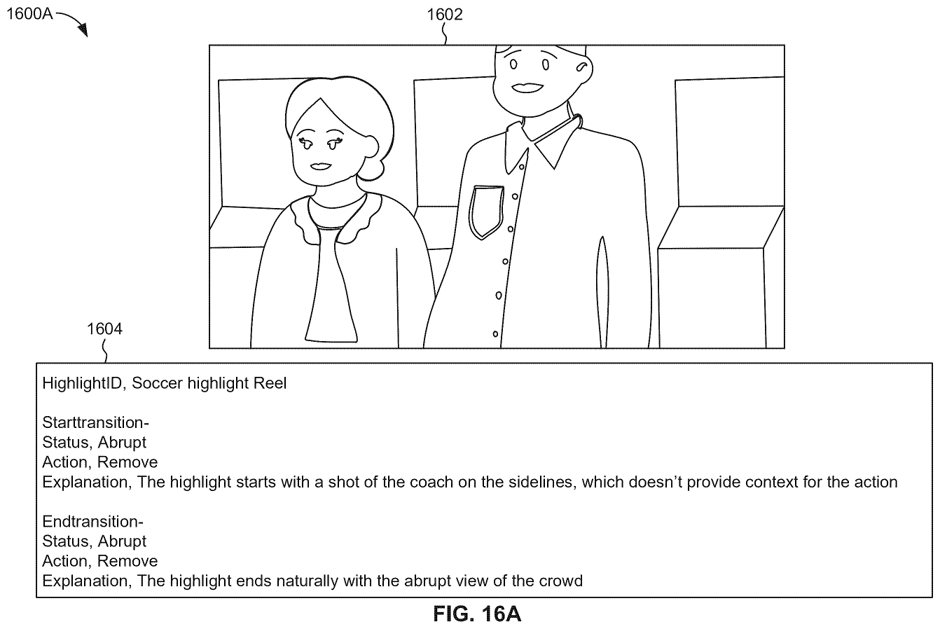

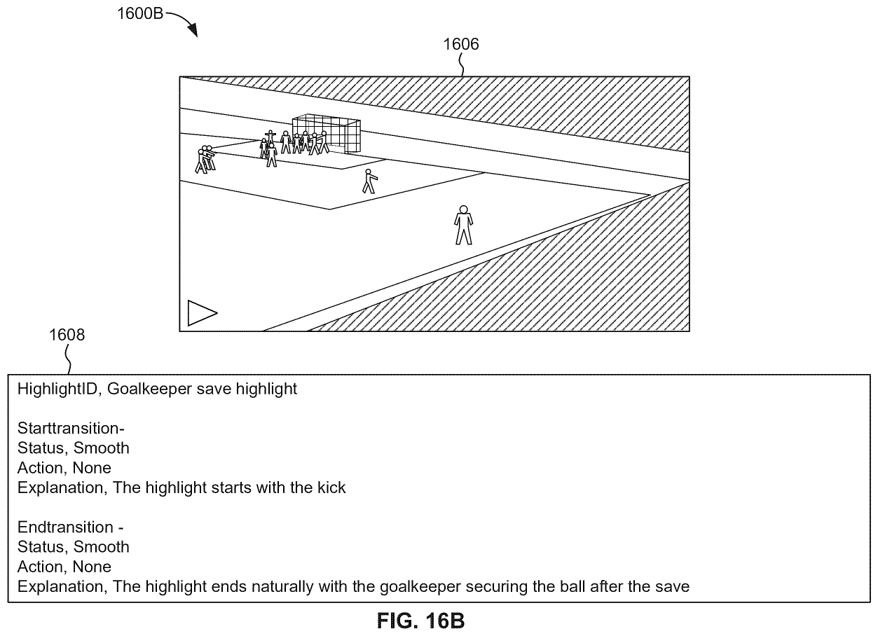

The processing engine 226 (acting as the lead video editor agent 226c) evaluates 1416 the highlight of the soccer match and provides 1418 constructive feedback or recommendation to improve quality of the highlight. The processing engine 226 may evaluate the highlight for completeness, smoothness, coherence, and/or the like. Based on the evaluation, the processing engine 226 may provide the constructive feedback/recommendation to improve the quality of the highlight. For example, the processing engine 226 evaluates whether a game start is smooth and in context and an ending is not abrupt. When it has been evaluated that the game start is not smooth and/or the ending is abrupt, the processing engine 226 provides the feedback to removal of the respective video feed or to include additional video feeds before or after the video feed for ensuring smoother transitions. Additionally, the processing engine 226 evaluates whether an ending of the highlights includes a start of a next play. When it has been evaluated that the ending of the highlights includes the start of the next play, the processing engine 226 provides the feedback to remove such a video feed to improve the quality of the highlight. An exemplary result 1600A of evaluating the highlight is depicted in FIG. 16A. The exemplary result 1600A includes a video feed 1602 and a description 1604 for the video feed 1602 indicating that a start transition and an end transition are abrupt. An exemplary result 1600B of evaluating the highlight is depicted in FIG. 16B. The exemplary result 1600B includes a video feed 1606 and a description 1608 for the video feed 1606 indicating that a start transition and an end transition are smooth.

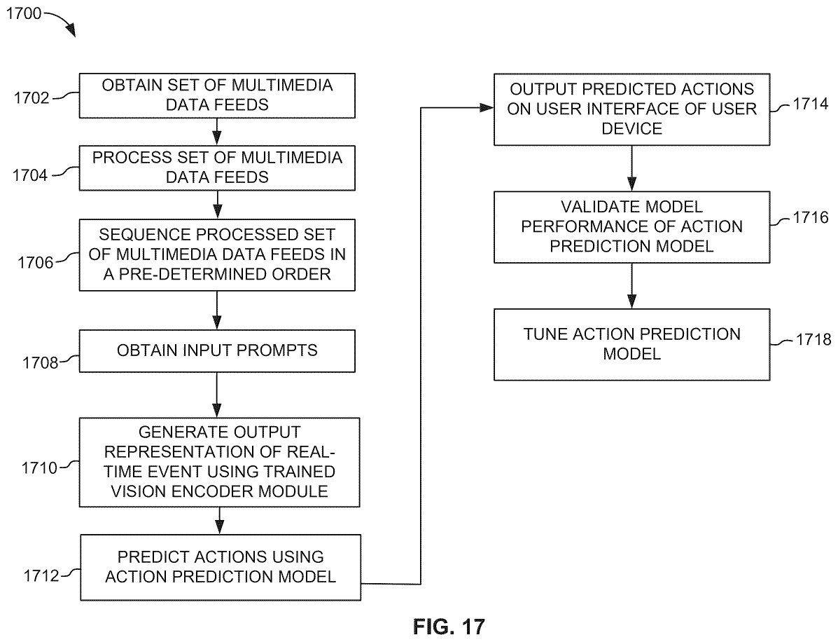

FIG. 17 is a flow diagram that presents a method 1700 for summarization of a real-time event and prediction of one or more actions in the summarized real-time event, in accordance with implementations of the present disclosure.

At step 1702, the method 1700 includes obtaining, by the processor 216, a set of multimedia data feeds. The set of multimedia data feeds are obtained from the image capturing devices 102a-102n. The set of multimedia data feeds corresponds to the real-time event (e.g., sporting event, surveillance, conference, concert, and/or the like). The set of multimedia data feeds corresponds to a time-series data captured at time intervals and a multi-resolution data captured from the image capturing devices 102a-102n. The set of multimedia data feeds may include text data, image data, audio data, and/or the like.

At step 1704, the method 1700 includes processing, by the processor 216, the obtained set of multimedia data feeds. The obtained set of multimedia data feeds are processed using a plurality of model hyperparameters. Examples of the model hyperparameters include, but are not limited to, a frame rate, a domain specific semantic compression, a multimedia segment length, and overlap between multimedia segments, and so on.

In some examples, for processing the obtained set of multimedia data feeds, a type of multimedia data in the set of multimedia data feeds may be identified by analyzing a file format, a data size, and contents of multimedia data. Further, one or more of a type of objects, a position of objects, gestures performed within the obtained set of multimedia data feeds, a text data, and an audio data may be identified using any of the computer vision model 208. Based on the identified type of multimedia data and the identified type of objects, the position of objects, the gestures performed within the obtained set of multimedia data feeds, the text data, and the audio data, the appropriate processing models 204 may be selected for processing the obtained set of multimedia data feeds. Using the selected appropriate processing models 204, the obtained set of multimedia data feeds may be processed. The selected appropriate processing models 204 may include the computer vision model 208 and the audio model 210. The computer vision model 208 may include one or more of: an object detection, an object tracking, a person detection, a person tracking, a semantic segmentation, a semantic compression, a multi-camera person recognition, and a multi-camera object recognition. The audio model 210 may include one or more of: a noise reduction, speech detection, and speech diarization. Further, the model hyperparameters may be tuned based on the selected appropriate processing models. Thereafter, the vision encoder model 212 may be retrained based on the tuned model hyperparameters.

Processing the obtained set of multimedia data feeds and tuning the model hyperparameters using the selected appropriate processing models and retraining the vision encoder model 212 may enhance accuracy and latency of the vision encoder model for generating output representations of real-time events. Further, processing the obtained set of multimedia data feeds including the semantic compression may reduce token size, latency, and hallucination of the vision encoder model. The model hyperparameters identified for retraining the vision encoder model 212 may enhance accuracy and latency of the vision encoder model 212.

In some other examples, for processing the obtained set of multimedia data feeds, an event of interest within the set of multimedia data feeds may be identified. Patterns corresponding to the identified event of interest with respect to different time instances may be determined by correlating each media frame with a subsequent media frame of the set of multimedia data feeds. Based on the patterns corresponding to the identified event of interest, the obtained set of multimedia data feeds may be processed.

At step 1706, the method 1700 includes sequencing, by the processor 216, the processed set of multimedia data feeds in a predetermined order. The processed set of multimedia data feeds is sequenced based on the time-series data and the multi-resolution data.

At step 1708, the method 1700 includes obtaining, by the processor 216, one or more input prompts. The one or more input prompts correspond to the set of multimedia data feeds from one or more input sources. In some examples, the text prompts may be obtained from the one or more input sources at real-time based on a type of the set of multimedia data feeds. The one or more input sources may include a user input, a model input, and/or the like. The one or more input prompts may include text prompts.

At step 1710, the method 1700 includes generating, by the processor 216, an output representation (summary/highlight) of the real-time event using the trained vision encoder model. The output representation is generated by encoding the sequenced set of multimedia data feeds and the obtained one or more input prompts using the trained vision encoder model. The generated output representation corresponds to a multi-resolution summary image of the real-time event at a time instance.

In some examples, for generating the output representation of the real-time event, the sequenced set of multimedia data feeds may be encoded using the computer vision encoder layer 802 of the trained vision encoder model 212. Encoding the sequenced set of multimedia data feeds using the computer vision encoder layer 802 may provide a capability to handle multi-resolution data and temporal information/patterns through stacking of the multimedia data feeds over time and across the image capturing devices 102a-102n.

Similarly, the obtained one or more input prompts may be encoded using the word embedding layer 804 of the trained vision encoder model 212. The encoded set of multimedia data feeds may be correlated with the encoded input prompts using the MoE layer 806 of the trained vision encoder model 212 to identify an action of interest. Based on the correlation, the output representation of the real-time event may be generated. The output representation may indicate the action of interest.

At step 1712, the method 1700 includes predicting, by the processor 216, one or more actions performed in the generated output representation using the action prediction model. Examples of the one or more actions include, but are not limited to, an activity, a function, and a movement corresponding to the real-time event.

In some examples, predicting the one or more actions include identifying one or more of: a type of objects, a position of objects, gestures performed within the obtained set of multimedia data feeds using the computer vision model 208. Based on one or more of: the type of the objects, the position of the objects, and the gestures performed, the set of multimedia data feeds may be classified into domain specific events. Further, a confidence score for each of the classified set of multimedia data feeds may be generated using the action prediction model. Using the generated action prediction model, the one or more actions performed in the generated output representation may be predicted.

At step 1714, the method 1700 includes outputting, by the processor 216, the predicted one or more actions on a user interface of the user device 104.

At step 1716, the method 1700 includes validating, by the processor 216, a model performance of the action prediction model 214. The model performance of the action prediction model 214 is validated based on key performance factors. Examples of the key performance factors include, but are not limited to, a data sensitivity factor, a data specificity factor, and a ground truth level of the action prediction model. At step 1718, the method 1700 includes tuning, by the processor 216, the action prediction model 214. The action prediction model 214 may be tuned to generate an updated action based on results of validation.

In some implementations, the method 1700 also includes determining, by the processor 216, one or more object patterns with an object within the obtained set of multimedia data feeds using the trained vision encoder model and detecting, by the processor 216, a state of the object based on the determined one or more patterns. In some examples, the state of the object may include one of a mental state and a physical state of the object.

Implementations of the present disclosure provide technical solutions to multiple technical problems that arise in the context of generating the summary/output representation of the real-time event corresponding to the set of multimedia data feeds. Implementations of the present disclosure provide a low latency domain specific multimodal framework that may be instruction fine-tuned based on latency and accuracy requirements. The domain specific multimodal framework may use an integration of the custom multi-modal model with the processing models (such as the computer vision models and the audio models) for generating the summary of the real-time event, while ensuring reliable and consistent performance of the custom multi-modal model.

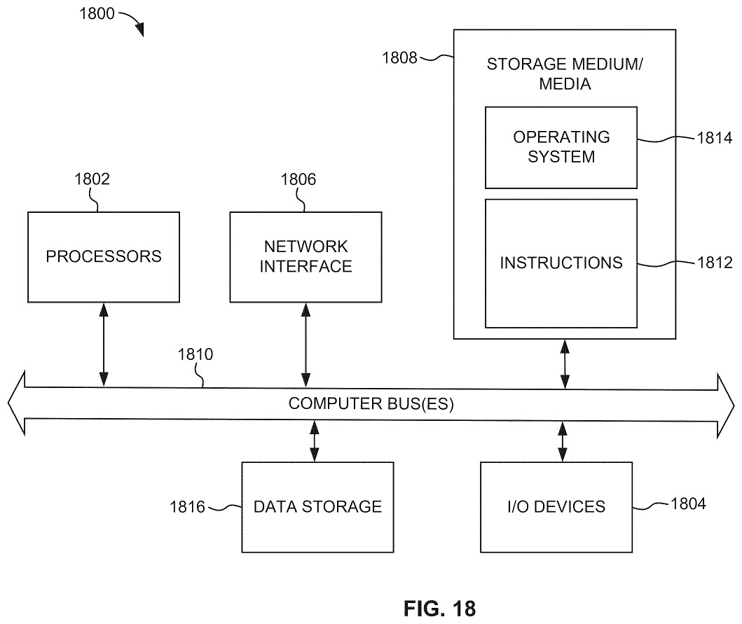

FIG. 18 depicts a computer system 1800 that may be used to implement the method 1700. More particularly, computing machines such as desktops, laptops, smartphones, tablets, and wearables which may be used to for summarization of a real-time event and prediction of one or more actions in the summarized real-time event. The computer system 1800 may include additional components not shown and that some of the process components described may be removed and/or modified. In another example, the computer system 1800 may be deployed on external-cloud platforms such as cloud, internal corporate cloud computing clusters, organizational computing resources, and/or the like.

The computer system 1800 includes processor(s) 1802, such as a central processing unit, ASIC or another type of processing circuit, input/output devices 1804, such as a display, mouse keyboard, and/or the like, a network interface 1806, such as a Local Area Network (LAN), a wireless 802.11x LAN, a 3G or 4G mobile WAN or a WiMax WAN, and a computer-readable medium 1808. Each of these components may be operatively coupled to a bus 1810. The computer-readable medium 1808 may be any suitable medium that participates in providing instructions to the processor(s) 1802 for execution. For example, the computer-readable medium 1808 may be non-transitory or non-volatile medium, such as a magnetic disk or solid-state non-volatile memory or volatile medium such as RAM. The instructions or modules stored on the computer-readable medium 1808 may include machine-readable instructions 1812 executed by the processor(s) 1802 that cause the processor(s) 1802 to perform the method 1700.

The computing system 1800 may be implemented as software stored on a non-transitory processor-readable medium and executed by the processor(s) 1802. For example, the computer-readable medium 1808 may store an operating system 1814, such as MAC OS, MS WINDOWS, UNIX, or LINUX, and code, for the computing system 1800. The operating system 1814 may be multi-user, multiprocessing, multitasking, multithreading, real-time, and the like. For example, during runtime, the operating system 1814 is running and the code for the computing system 1800 is executed by the processor(s) 1802.

The computer system 1800 may include a data storage 1816, which may include non-volatile data storage. The data storage 1816 stores any data used or generated by the computer system 1800.

The network interface 1806 connects the computer system 1800 to internal systems for example, via a LAN. Also, the network interface 1806 may connect the computer system 1800 to the Internet. For example, the computer system 1800 may connect to web browsers and other external applications and systems via the network interface 1806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 1802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
obtain a set of multimedia data feeds from a plurality of image capturing devices, wherein the set of multimedia data feeds correspond to a real-time event, and wherein the set of multimedia data feeds correspond to a time-series data captured at a plurality of time intervals and a multi-resolution data captured from the plurality of image capturing devices;
process the obtained set of multimedia data feeds using a plurality of model hyperparameters, wherein the plurality of hyperparameters comprise a frame rate, a domain specific semantic compression, a multimedia segment length, and overlap between multimedia segments;
sequence the processed set of multimedia data feeds in a predetermined order based on the time-series data and the multi-resolution data;
obtain at least one input prompt corresponding to the set of multimedia data feeds from at least one input source;
generate an output representation of the real-time event by encoding the sequenced set of multimedia data feeds and the obtained at least one input prompt using a trained vision encoder model, wherein the generated output representation corresponds to a multi-resolution summary image of the real-time event at a time instance;
predict at least one action performed in the generated output representation using an action prediction model, wherein the at least one action comprises at least one of an activity, a function, and a movement corresponding to the real-time event; and
output the predicted at least one action on a user interface of a user device.

2. The system of claim 1, wherein the processor is configured to:
validate a model performance of the action prediction model based on key performance factors, wherein the key performance factors comprise a data sensitivity factor, a data specificity factor, and a ground truth level of the action prediction model; and
tune the action prediction model to generate an updated action based on results of validation.

3. The system of claim 1, wherein to process the obtained set of multimedia data feeds using a plurality of model hyperparameters, the processor is configured to:
identify a type of multimedia data obtained by analyzing a file format, a data size, and contents of multimedia data;
identify at least one of a type of objects, a position of objects, gestures performed within the obtained set of multimedia data feeds, a text data, and an audio data using a computer vision model;
select at least one appropriate processing model for processing the obtained set of multimedia data feeds based on the identified type of multimedia data, and the identified type of objects, the position of objects, the gestures performed within the obtained set of multimedia data feeds, the text data, and the audio data; and
process the obtained set of multimedia data feeds using the selected at least one appropriate processing model.

4. The system of claim 3, wherein the processor is configured to:
tune the plurality of model hyperparameters based on the selected at least one appropriate processing model, wherein the selected at least one appropriate processing model comprises a computer vision model and an audio model, wherein the computer vision model comprises at least one of an object detection, an object tracking, a person detection, a person tracking, a semantic segmentation, a semantic compression, a multi-camera person recognition, and a multi-camera object recognition, wherein the audio model comprises a noise reduction, a speech detection, and a speech diarization; and
retrain a vision encoder model based on the tuned plurality of model hyperparameters.

5. The system of claim 1, wherein to obtain the at least one input prompt corresponding to the set of multimedia data feeds from at least one input source the processor is configured to:
obtain text prompts from at least one input source at real-time based on a type of the set of multimedia data feeds, wherein the at least one input source comprises one of a user input, and a model input.

6. The system of claim 1, wherein to process the obtained set of multimedia data feeds using the plurality of model hyperparameters, the processor is configured to:
identify an event of interest within the set of multimedia data feeds captured from the plurality of image capturing devices;
determine a plurality of patterns corresponding to the identified event of interest with respect to a plurality of time instances by correlating each media frame with a subsequent media frame of the set of multimedia data feeds; and
process the obtained set of multimedia data feeds based on the determined plurality of patterns corresponding to the identified event of interest.

7. The system of claim 1, wherein to generate the output representation of the real-time event by encoding the sequenced set of multimedia data feeds and the obtained at least one input prompt using the trained vision encoder model, the processor is configured to:
encode the sequenced set of multimedia data feeds using a computer vision encoder layer of the trained vision encoder model;
encode the obtained at least one input prompt using a word embedding layer of the trained vision encoder model;
correlate the encoded set of multimedia data feeds with the obtained at least one input prompt to identify an action of interest; and
generate the output representation of the real-time event based on the correlation, wherein the output representation indicates the action of interest.

8. The system of claim 1, wherein to predict the at least one action performed in the generated output representation using the action prediction model, the processor is configured to:
identify at least one of a type of objects, a position of objects, gestures performed within the obtained set of multimedia data feeds using a computer vision model;
classify the set of multimedia data feeds into domain specific events based on the at least one of the type of the objects, the position of the objects, and the gestures performed;
generate a confidence score for each of the classified set of multimedia data feeds using the action prediction model; and
predict the at least one action performed in the generated output representation using the generated confidence score.

9. The system of claim 1, wherein the processor is configured to:
determine at one pattern with an object within the obtained set of multimedia data feeds using the trained vision encoder model; and
detect a state of the object based on the determined at least one pattern, wherein the state of the object comprises one of a mental state and a physical state of the object.

10. A method comprising:
obtaining, by a processor, a set of multimedia data feeds from a plurality of image capturing devices, wherein the set of multimedia data feeds correspond to a real-time event, and wherein the set of multimedia data feeds correspond to a time-series data captured at a plurality of time intervals and a multi-resolution data captured from the plurality of image capturing devices;
processing, by the processor, the obtained set of multimedia data feeds using a plurality of model hyperparameters, wherein the plurality of hyperparameters comprise a frame rate, a domain specific semantic compression, a multimedia segment length, and overlap between multimedia segments;
sequencing, by the processor, the processed set of multimedia data feeds in a predetermined order based on the time-series data and the multi-resolution data;
obtaining, by the processor, at least one input prompt corresponding to the set of multimedia data feeds from at least one input source;
generating, by the processor, an output representation of the real-time event by encoding the sequenced set of multimedia data feeds and the obtained at least one input prompt using a trained vision encoder model, wherein the generated output representation corresponds to a multi-resolution summary image of the real-time event at a time instance;
predicting, by the processor, at least one action performed in the generated output representation using an action prediction model, wherein the at least one action comprises at least one of an activity, a function, and a movement corresponding to the real-time event; and
outputting, by the processor, the predicted at least one action on a user interface of a user device.

11. The method of claim 10, further comprising:
validating, by the processor, a model performance of the action prediction model based on key performance factors, wherein the key performance factors comprise a data sensitivity factor, a data specificity factor, and a ground truth level of the action prediction model; and
tuning, by the processor, the action prediction model to generate an updated action based on results of validation.

12. The method of claim 10, wherein processing the obtained set of multimedia data feeds using a plurality of model hyperparameters comprises:
identifying, by the processor, a type of multimedia data obtained by analyzing a file format, a data size, and contents of multimedia data;
identifying, by the processor, at least one of a type of objects, a position of objects, gestures performed within the obtained set of multimedia data feeds, a text data, and an audio data using a computer vision model;
selecting, by the processor, at least one appropriate processing model for processing the obtained set of multimedia data feeds based on the identified type of multimedia data, and the identified type of objects, the position of objects, the gestures performed within the obtained set of multimedia data feeds, the text data, and the audio data; and
processing, by the processor, the obtained set of multimedia data feeds using the selected at least one appropriate processing model.

13. The method of claim 12, further comprising:
tuning, by the processor, the plurality of model hyperparameters based on the selected at least one appropriate processing model, wherein the selected at least one appropriate processing model comprises a computer vision model and an audio model, wherein the appropriate computer vision model comprises at least one of an object detection, an object tracking, a person detection, a person tracking, a semantic segmentation, a semantic compression, a multi-camera person recognition, and a multi-camera object recognition, wherein the audio model comprises a noise reduction, a speech detection, and a speech diarization; and
retraining, by the processor, a vision encoder model based on the tuned plurality of model hyperparameters.

14. The method of claim 10, wherein obtaining the at least one input prompt corresponding to the set of multimedia data feeds from at least one input source comprises:
obtaining, by the processor, text prompts from at least one input source at real-time based on a type of the set of multimedia data feeds, wherein the at least one input source comprises one of a user input, and a model input.

15. The method of claim 10, wherein processing the obtained set of multimedia data feeds using the plurality of model hyperparameters comprises:
identifying, by the processor, an event of interest within the set of multimedia data feeds captured from the plurality of image capturing devices;
determining, by the processor, a plurality of patterns corresponding to the identified event of interest with respect to a plurality of time instances by correlating each media frame with a subsequent media frame of the set of multimedia data feeds; and
processing, by the processor, the obtained set of multimedia data feeds based on the determined plurality of patterns corresponding to the identified event of interest.

16. The method of claim 10, wherein generating the output representation of the real-time event by encoding the sequenced set of multimedia data feeds and the obtained at least one input prompt using the trained vision encoder model comprises:
encoding, by the processor, the sequenced set of multimedia data feeds using a computer vision encoder layer of the trained vision encoder model;
encoding, by the processor, the obtained at least one input prompt using a word embedding layer of the trained vision encoder model;
correlating, by the processor, the encoded set of multimedia data feeds with the obtained at least one input prompt to identify an action of interest; and
generating, by the processor, the output representation of the real-time event based on the correlation, wherein the output representation indicates the action of interest.

17. The method of claim 10, wherein predicting the at least one action performed in the generated output representation using the action prediction model comprises:
identifying, by the processor, at least one of a type of objects, a position of objects, gestures performed within the obtained set of multimedia data feeds using a computer vision model;
classifying, by the processor, the set of multimedia data feeds into domain specific events based on the at least one of the type of the objects, the position of the objects, and the gestures performed;
generating, by the processor, a confidence score for each of the classified set of multimedia data feeds using the action prediction model; and
predicting, by the processor, the at least one action performed in the generated output representation using the generated confidence score.

18. The method of claim 10, further comprising:
determining, by the processor, at one pattern with an object within the obtained set of multimedia data feeds using the trained vision encoder model; and
detecting, by the processor, a state of the object based on the determined at least one pattern, wherein the state of the object comprises one of a mental state and a physical state of the object.

19. A non-transitory computer readable medium comprising a processor-executable instructions that cause a processor to:
obtain a set of multimedia data feeds from a plurality of image capturing devices, wherein the set of multimedia data feeds correspond to a real-time event, and wherein the set of multimedia data feeds correspond to a time-series data captured at a plurality of time intervals and a multi-resolution data captured from the plurality of image capturing devices;
process the obtained set of multimedia data feeds using a plurality of model hyperparameters, wherein the plurality of hyperparameters comprise a frame rate, a domain specific semantic compression, a multimedia segment length, and overlap between multimedia segments;
sequence the processed set of multimedia data feeds in a predetermined order based on the time-series data and the multi-resolution data;
obtain at least one input prompt corresponding to the set of multimedia data feeds from at least one input source;
generate an output representation of the real-time event by encoding the sequenced set of multimedia data feeds and the obtained at least one input prompt using a trained vision encoder model, wherein the generated output representation corresponds to a multi-resolution summary image of the real-time event at a time instance;
predict at least one action performed in the generated output representation using an action prediction model, wherein the at least one action comprises at least one of an activity, a function, and a movement corresponding to the real-time event; and
output the predicted at least one action on a user interface of a user device.

20. The non-transitory computer readable medium of claim 19, wherein the processor-executable instructions cause the processor to:
tune the plurality of model hyperparameters based on selected at least one appropriate processing model, wherein the selected at least one appropriate processing model comprises a computer vision model and an audio model, wherein the computer vision model comprises at least one of an object detection, an object tracking, a person detection, a person tracking, a semantic segmentation, a semantic compression, a multi-camera person recognition, and a multi-camera object recognition, wherein the audio model comprises a noise reduction, a speech detection, and a speech diarization; and
retrain a vision encoder model based on the tuned plurality of model hyperparameters.
